(19) United States
(12) Patent Application Publication
(10) Pub. No.: US 2018/0262503 A1
(43) Pub. Date: Sep. 13, 2018

(54) USER-GENERATED SESSION PASSCODE FOR RE-AUTHENTICATION

(71) Applicant: RESCON LTD, Crondall (GB)

(72) Inventors: Laura Miranda Dawson, Medstead (GB); Thomas Andrew DAWSON, Medstead (GB)

(21) Appl. No.: 15/914,972

(22) Filed: Mar. 7, 2018

Related U.S. Application Data
(60) Provisional application No. 62/468,359, filed on Mar. 7, 2017.
(60) Provisional application No. 62/541,744, filed on Aug. 6, 2017.

(51) Int. Cl. H04L 29/06; H04L 9/06; H04L 9/32; H04L 9/08

(52) U.S. Cl. CPC H04L 63/0884; H04L 63/083; H04L 9/0643; H04L 63/0428; H04L 63/0861; H04L 9/0861; H04L 9/3239

(57) ABSTRACT

A user generates a single session passcode after a normal authentication has been used to access a system. This single session passcode thereafter is used to re-authenticate the user during the session without requiring the repeated use of the normal authentication. Such re-authentication may occur, for example, upon a timeout event, or when the user attempts to access resources, data, or areas within the system that are more secure than other resources, data, or areas within the system that are accessible following the start of the session.

### CROSS-REFERENCE TO RELATED APPLICATION

The present application is a nonprovisional patent application of, and claims priority under 35 U.S.C. § 119(e) to, each of U.S. provisional patent application 62/468,359, filed Mar. 7, 2017; and U.S. provisional patent application 62/541,744, filed Aug. 6, 2017. The disclosure of each provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to authentication methodologies for electronic systems and platforms.

Electronic platforms and systems are becoming more and more ubiquitous every year. While some electronic platforms and systems are intended to be open to any and all users, and require no authentication, there exist many electronic platforms and systems where there is a desire to restrict access, e.g., to certain users.

A very common methodology for restricting access to an electronic system involves the use of authentication information. For example, a system may require the input of authentication information in the form of a specific username and password before a user may access the system.

There is an ongoing struggle between the need to robustly authenticate the identities of people or autonomous entities, and the need to create systems that are easy to use with minimal barriers to entry. Over time, various technologies have been developed to overcome issues with the creation and recall of passwords of increasing complexity. Based on the development of such technologies, the death of the password was predicted at least as early as fifteen years ago. However, this prediction assumed that alternative methods would be adopted to control access to information technology infrastructure, data, and other sensitive areas. Despite this prediction, and the development of various technologies, since this time, password use has increased.

This increase has been driven by an increase in online services where passwords are easy to implement and low cost. The increase in password use combined with increasing demand for complex password requirements has often outstripped the human capacity for memory and recall of such passwords. As a result, many users have devised mechanisms to cope with password overload, such as reusing the same password across many systems, using simple and predictable password creation strategies, and writing down passwords (e.g., somewhere that another individual might find them). All of these strategies leave systems prone to attack.

Various approaches have been utilized to attempt to discover a user's password. Some of these approaches represent social engineering approaches, e.g., phishing, or coercion. Some approaches involve manual password guessing, perhaps using personal information ‘cribs’ such as name, date of birth, or pet names. Another approach involves intercepting a password as it is transmitted over a network. Another approach involves observing someone typing in his or her password, e.g., shoulder surfing. Another approach involves utilizing a key logger to intercept passwords as they are entered into a device. Another approach involves searching an enterprise's information technology infrastructure for electronically stored password information. Another approach involves utilizing brute force attacks representing the automated guessing of a large number of passwords until a correct one is found. Another approach involves locating passwords that have been stored insecurely, such as handwritten on paper and hidden close to a device. Another approach involves compromising a database containing a large number of user passwords, then using this information to attack other systems where users have re-used these passwords.

There exist a variety of known approaches to overcoming these issues. Some of these approaches are summarized, for example, in the United Kingdom National Cyber Security Centre online guidance. The strategic approaches detailed in that guidance include seven recommendations for system security.

A first of these recommendations relates to changing all default passwords. This involves changing all default passwords before deployment, and carrying out a regular check of system devices and software, specifically to look for unchanged default passwords, prioritizing essential infrastructure devices.

A second of these recommendations relates to helping users cope with password overload. This can involve only using passwords where they are really needed, using technical solutions to reduce the burden on users, allowing users to securely record and store their passwords, only asking users to change their passwords on indication or suspicion of compromise, allowing users to reset passwords easily, quickly and cheaply, and prohibiting password sharing. Password management software can help users, but carries risks.

A third of these recommendations relates to understanding the limitations of user-generated passwords. This can involve putting technical defenses in place so that simpler password policies can be used, reinforcing policies with good user training, steering users away from choosing predictable passwords, and prohibiting the most common ones by blacklisting. This further can involve reminding users that work passwords protect important assets and they should never re-use passwords between work and home. This additionally can involve being aware of the limitations of password strength meters.

A fourth of these recommendations relates to understanding the limitations of machine-generated passwords. This can involve choosing a scheme that produces passwords that are easier to remember, offer a choice of passwords, so users can select one they find memorable. As with user-generated passwords, this can involve reminding users that work passwords protect important assets and they should never re-use passwords between work and home.

A fifth of these recommendations relates to prioritizing administrator and remote user accounts. This can involve giving administrators, remote users, and mobile devices extra protection. This can involve requiring administrators to use different passwords for their administrative and non-administrative accounts. This can involve not routinely granting administrator privileges to standard users. This can involve implementing two-factor authentication for all remote accounts. This can involve making sure that absolutely no default administrator passwords are used.

A sixth of these recommendations relates to user account lockout and protective monitoring. Account lockout and ‘throttling’ are effective methods of defending brute-force attacks. This can involve allowing a user a limited number of login attempts (e.g., ten) before locking out an account. This can involve password blacklisting in combination with lockout or throttling. This can further involve use of protective monitoring as a defense against brute-force attacks, which can be used alternatively to or additionally with account lockout or throttling. When outsourcing, contractual agreements should stipulate how user credentials are protected.

A seventh of these recommendations relates to not storing passwords as plain text. This can involve producing hashed representations of passwords using a unique salt for each account. This can involve storing passwords in a hashed format, produced using a cryptographic function capable of multiple iterations (e.g., SHA 256). This can further involve ensuring you protect files containing encrypted or hashed passwords from unauthorized system or user access. This can additionally involve, when implementing password solutions, using public standards, such as PBKDF2, which use multiple iterated hashes.

Many organizations require complex passwords, often changed regularly, in order for users to access sensitive data. Often this process makes user authentication less, rather than more, secure because long, regularly changing passwords with random characters are difficult to remember so users tend to write them down and often store them insecurely.

To access sensitive data, sometimes a second layer of data entry is required, such as an additional password, passcode, phrase, or PIN. In more secure systems, a unique identity card or biometric data such as a finger print or retina scan can be used.

The addition of a second password, passcode, phrase, or PIN does not necessarily increase security as it is yet another item to remember and a user who has already written down his or her complicated password is likely to write down and store his or her second password, passcode, phrase, or PIN in close physical or file (e.g., within an electronic document) proximity to the first.

Many systems also use authorization tokens (e.g., OAUTH) as a form of authentication to prevent a user from having to repeatedly sign in. This keeps a user “signed in” for long periods of time by storing an authorization token on the user's system. In order to generate the token in the first place, the user must enter their username and password, but if the token is stolen after this point the thief does not need a username and password in order to gain access to the system.

Computer controlled access to systems whether they are computer based or physical has become increasingly important for the communication, processing and storage of sensitive materials (e.g., medical records) or processes (e.g., system to launch missiles) whether those materials (e.g., restricted security documentation) or processes (e.g., nuclear power plant control room) are data based or physical (e.g., location specific). Due to the high value of these materials or processes they are often the target of unauthorized access with negative intent. Providing authentication gateways to a system or sensitive area of a system is one way of preserving system security and integrity. The primary role of an authentication gateway is to verify the credentials of a user who is requesting access to a secure system.

As described above, many systems are designed to gate access using single factor static authentication requiring a username and password pair to log into the system with increasing complexity of the password depending on security requirements. This type of system has flaws due to difficulties in both generation of complex passwords and user recall of these passwords.

Additional methods have been created to further authenticate a user such as multi-factor authentication requiring additional ways of authenticating a user such as a physical or computer readable key (e.g., bank card), or biometrics.

Though these systems are all workable, there are areas where security refinements can be made.

One of these areas involves a problem with static authentication methodologies. By being static, a security system can be prone to a variety of attacks, some of which were referenced hereinabove.

Perhaps based on a recognition of the limitation of static authentication methodologies, one approach that has been utilized involves dynamic authentication methodologies. For example, there exist approaches which utilize cryptography and/or other techniques to create a one session authentication. A one-time password is an example of dynamic authentication. Such a one-time password is valid for only one login session or transaction. One-time or session limited passwords can avoid many of the static authentication security issues presented by static authentication methodologies; for example, even if a one-time password is compromised, it will expire. As a result, there have been considerable developments in new technologies that can generate authenticated dynamic or session limited passwords.

A first example is provided by a methodology for the European web portal Altinn, which utilizes a methodology involving a single session Personal Identification Number (PIN) where a computer system will generate a PIN and send it to a user via the internet and/or mobile network Short Messaging Service (SMS).

A second example is disclosed in U.S. Patent Application Pub. No. 2014/0282962 to Harrison. This patent publication describes how a trusted communication device may generate and display a single use user ID and/or password to be utilized for one time validation of a communication session between an unsecure communication device and a secure communication device.

A third example is disclosed in U.S. Patent Application Pub. No. 2016/0381009 to Liou. This patent publication describes the generation of a one-time passcode by a computer system.

Although securing an initial user authentication is important, there exist various ways that a secure system may be compromised following an initial user login. For example, a user who has logged in to a secure system at a device may leave the device without logging out or securing the device, leaving the secure system open to any individual who accesses the device.

One approach that has been utilized to address this concern involves the practice of timing out a user from a secure system after a period of non-use. Many secure systems utilize a timeout methodology to prevent unauthorized access to a system that might be left “open” when a user is away. This time out would then require a user to enter all their credentials again to access the system. However, this can be considerably disruptive to a user who frequently needs to leave a sensitive system to attend to another task. An example of this is a doctor who is entering clinical notes and needs to attend to an urgent patient matter. When they come back, they are logged out. Logging back in and authenticating takes time, especially if the user has a complex password that is difficult to remember. The user may even have to access that password from a physically secure location (such as a locked cabinet), all of which takes up further time and disrupts workflow.

Additionally, there exist complex systems where different areas of the system, or different pieces of data within the system, have different security levels. An example of this is healthcare management software where access to sensitive patient data within parts of the system may be required. To access a more secure part of a system, further authentication may be required, which just adds a further requirement on memory or the need to lock a further password physically away, which would need to be in a separate location from the first.

Needs exist for improvement in authentication methodologies for electronic systems and platforms. These needs and other needs are addressed by one or more aspects of the present invention.

### SUMMARY OF THE INVENTION

The present invention includes many aspects and features. Moreover, while many aspects and features relate to, and are described in, a particular context, the present invention is not limited to use only in such context, as will become apparent from the following summaries and detailed descriptions of aspects, features, and one or more embodiments of the present invention.

Accordingly, one aspect of the present invention relates to a method comprising first, receiving, from a user via one or more input devices associated with an electronic device, user input corresponding to authorization credentials for an electronic system; communicating, from the user device to an authentication service for the electronic system, authentication information for the user based on the input authorization credentials; determining, by the authentication service based on the received authentication information, that the user is an authorized user, and based thereon returning an authentication indication to the user device; receiving, at the user device, the authentication indication, and based thereon, displaying, to the user via a display associated with the electronic device, an interface soliciting entry of a session passcode; receiving, at the user device from the user via one or more input devices associated with the electronic device, user input corresponding to entry of a session passcode; communicating, from the electronic device to the authentication service, an indication of the session passcode; and storing, by the authentication service at a secure database associated with the electronic system, a hash of the session passcode. The method further comprises, thereafter, determining that a timeout period has passed since user activity at the user device; based on the determination that a timeout period has passed since user activity at the user device, displaying, to the user via a display associated with the electronic device, an interface soliciting entry of the session passcode; receiving, at the user device from the user via one or more input devices associated with the electronic device, user input corresponding to entry of an “attempted” or “suspect” session passcode; communicating, from the electronic device to the authentication service, an indication of the suspect passcode; comparing, by the authentication service, a hash of the suspect session passcode to the stored hash of the session passcode and determining that the hash of the suspect session passcode matches the stored hash of the session passcode; based on the determination that the hash of the suspect session passcode matches the stored hash of the session passcode, communicating, by the authentication service, a re-authentication indication to the electronic device; and receiving, at the electronic device, the communicated re-authentication indication, and, based thereon, allowing the user continued access to the electronic system.

In a feature of this aspect, the authentication service is remote from the electronic device.

In a feature of this aspect, the authentication service is local to the electronic device with virtual or close physical separation.

In a feature of this aspect, the authentication service is remote from servers forming part of the electronic system.

In a feature of this aspect, the authentication service is local to servers forming part of the electronic system, with virtual or close physical separation.

In a feature of this aspect, the electronic system comprises a cloud platform.

In a feature of this aspect, the electronic system comprises an online platform.

In a feature of this aspect, the electronic system comprises a server.

In a feature of this aspect, the electronic system comprises a database system.

In a feature of this aspect, the electronic system comprises a medical records system.

In a feature of this aspect, the authorization credentials comprise a username and password.

In a feature of this aspect, the authorization credentials comprise biometric authentication.

In a feature of this aspect, the authorization credentials comprise a retinal scan or fingerprint scan.

In a feature of this aspect, the electronic device comprises a desktop computer.

In a feature of this aspect, the electronic device comprises a laptop computer.

In a feature of this aspect, the electronic device comprises a phone.

In a feature of this aspect, the electronic device comprises a tablet.

In a feature of this aspect, the electronic device comprises a touchscreen device, and wherein receiving, at the user device from the user via one or more input devices associated with the electronic device, user input corresponding to entry of a session passcode comprises receiving user input via a touchscreen of the touchscreen device.

In a feature of this aspect, the session passcode comprises an alphanumeric string.

In a feature of this aspect, the session passcode comprises a personal identification number.

In a feature of this aspect, the session passcode comprises one or more user-selected images.

Another aspect relates to a method comprising first, receiving, from a user via one or more input devices associated with an electronic device, user input corresponding to authorization credentials for an electronic system; communicating, from the user device to an authentication service for the electronic system, authentication information for the user based on the input authorization credentials; determining, by the authentication service based on the received authentication information, that the user is an authorized user, and based thereon returning an authentication indication to the user device; receiving, at the user device, the authentication indication, and based thereon, displaying, to the user via a display associated with the electronic device, an interface soliciting entry of a session passcode; receiving, at the user device from the user via one or more input devices associated with the electronic device, user input corresponding to entry of a session passcode; communicating, from the electronic device to the authentication service, an indication of the session passcode; and storing, by the authentication service at a secure database associated with the electronic system, a hash of the session passcode. The method further comprises, thereafter, determining that the user has suspect to access a more secure area of the electronic system; based on the determination that the user has suspect to access a more secure area of the electronic system, displaying, to the user via a display associated with the electronic device, an interface soliciting entry of the session passcode; receiving, at the user device from the user via one or more input devices associated with the electronic device, user input corresponding to entry of a suspect session passcode; communicating, from the electronic device to the authentication service, an indication of the suspect session passcode; comparing, by the authentication service, a hash of the suspect session passcode to the stored hash of the session passcode and determining that the hash of the suspect session passcode matches the stored hash of the session passcode; based on the determination that the hash of the suspect session passcode matches the stored hash of the session passcode, communicating, by the authentication service, a re-authentication indication to the electronic device; and receiving, at the electronic device, the communicated re-authentication indication, and, based thereon, allowing the user continued access to the electronic system.

Another aspect relates to a method comprising first, receiving, from a user via one or more input devices associated with an electronic device, user input corresponding to authorization credentials for an electronic system; communicating, from the user device to an authentication service for the electronic system, authentication information for the user based on the input authorization credentials; determining, by the authentication service based on the received authentication information, that the user is an authorized user, and based thereon returning an authorization token to the user device; receiving, at the user device, the original authorization token, and based thereon storing the received original authorization token at the user device and displaying, to the user via a display associated with the electronic device, an interface soliciting entry of a session passcode; receiving, at the user device from the user via one or more input devices associated with the electronic device, user input corresponding to entry of a session passcode; communicating, from the electronic device to the authentication service, an indication of the session passcode; integrating, by the authentication service, a hash of the session passcode into the authentication token; and storing, by the authentication service in a secure data store, the authentication token including the hash of the session passcode integrated therein. The method further comprises, thereafter, determining that an event has occurred requiring re-authentication of the user; based on the determination that an event has occurred requiring re-authentication of the user, displaying, to the user via a display associated with the electronic device, an interface soliciting entry of the session passcode; receiving, at the user device from the user via one or more input devices associated with the electronic device, user input corresponding to entry of a suspect session passcode; integrating, at the electronic device, a hash of the suspect session passcode into the original authentication token; communicating, from the electronic device to the authentication service, the authentication token including the hash of the suspect session passcode integrated therein; comparing, by the authentication service, the received authentication token including the hash of the suspect session passcode integrated therein to the stored authentication token including the hash of the session passcode integrated therein and determining that they match; based on the determination that they match, communicating, by the authentication service, a re-authentication indication to the electronic device; and receiving, at the electronic device, the communicated re-authentication indication, and, based thereon, allowing the user continued access to the electronic system.

In a feature of this aspect, the original authorization token comprises an OAuth token.

Another aspect relates to a method comprising first, receiving, from a user via one or more input devices associated with an electronic device, user input corresponding to authorization credentials for an electronic system; communicating, from the user device to an authentication service for the electronic system, authentication information for the user based on the input authorization credentials; determining, by the authentication service based on the received authentication information, that the user is an authorized user, and based thereon returning an authorization token to the user device; receiving, at the user device, the original authorization token, and based thereon storing the received original authorization token at the user device and displaying, to the user via a display associated with the electronic device, an interface soliciting entry of a session passcode; receiving, at the user device from the user via one or more input devices associated with the electronic device, user input corresponding to entry of a session passcode; and integrating a hash of the session passcode into the authentication token, and storing, by the authentication service in a secure data store, the authentication token including the hash of the session passcode integrated therein. The method further comprises, thereafter, determining that an event has occurred requiring re-authentication of the user; based on the determination that an event has occurred requiring re-authentication of the user, displaying, to the user via a display associated with the electronic device, an interface soliciting entry of the session passcode; receiving, at the user device from the user via one or more input devices associated with the electronic device, user input corresponding to entry of a suspect session passcode; integrating a hash of the suspect session passcode into the original authentication token; comparing, by the authentication service, the received authentication token including the hash of the suspect session passcode integrated therein to the stored authentication token including the hash of the session passcode integrated therein and determining that they match; based on the determination that they match, communicating, by the authentication service, a re-authentication indication to the electronic device; and receiving, at the electronic device, the communicated re-authentication indication, and, based thereon, allowing the user continued access to the electronic system.

Another aspect relates to a method comprising first, receiving, from a user via one or more input devices associated with an electronic device, user input corresponding to full authorization credentials for an electronic system; communicating, from the user device to the electronic system, authentication information for the user based on the input full authorization credentials; determining, by the electronic system based on the received authentication information, that the user is an authorized user, and based thereon returning an authentication indication to the user device; receiving, at the user device, the authentication indication, and based thereon, displaying, to the user via a display associated with the electronic device, an interface soliciting entry or selection of temporary authentication credentials; receiving, at the user device from the user via one or more input devices associated with the electronic device, user input corresponding to entry or selection of temporary authorization credentials; communicating, from the electronic device to the electronic system, an indication of the temporary authorization credentials; and storing, by the electronic system at a secure database associated with the electronic system, data corresponding to the temporary authorization credentials. The method further comprises, thereafter, determining that an event has occurred requiring re-authentication; based on the determination that an event has occurred requiring re-authentication, displaying, to the user via a display associated with the electronic device, an interface soliciting entry of the temporary authorization credentials; receiving, at the user device from the user via one or more input devices associated with the electronic device, user input corresponding to entry of suspect temporary authorization credentials; communicating, from the electronic device to the electronic system, an indication of the suspect temporary authorization credentials; comparing, by the electronic system, data corresponding to the suspect temporary authorization credentials to the stored data corresponding to the temporary authorization credentials and determining that they match; based on the determination that they match, communicating, by the electronic system, a re-authentication indication to the electronic device; and receiving, at the electronic device, the communicated re-authentication indication, and, based thereon, allowing the user continued access to the electronic system.

In a feature of this aspect, temporary authorization credentials are utilized for generation of a decryption key.

In a feature of this aspect, data is encrypted by the electronic system before communication to the electronic device, and the temporary authorization credentials can be utilized as a decryption key for decryption of the communicated encrypted data at the electronic device.

Another aspect relates to an electronic device comprising a processor; memory; an electronic display; storage comprising an authorization token for the electronic system received following user login to an electronic system with first authorization credentials, an application configured to prompt a user for first authorization credentials to login to the electronic system and receive authorization tokens based thereon, and following login to the electronic system, prompt a user for second temporary authorization credentials to be used for re-authentication during a session and communicate an indication of input temporary authorization credentials to the electronic system, upon a need to re-authenticate, prompt a user for the second temporary authorization credentials, integrate a hash of newly input second temporary authorization credentials into the stored authorization token to form a combined authorization token, and communicate the combined authorization token to the electronic system for re-authentication.

Another aspect relates to an electronic device comprising a processor; memory; an electronic display; storage comprising encrypted data from an electronic resource; a portion of a decryption key for the encrypted data received following user login to the electronic resource with first authorization credentials, an application configured to prompt a user for first authorization credentials to login to the electronic resource, and following login to the electronic resource, prompt a user for second temporary authorization credentials to be used for re-authentication for decryption, upon a need to re-authenticate, prompt a user for the second temporary authorization credentials, integrate a hash of newly input second temporary authorization credentials into the stored portion of the decryption key to form a combined decryption key, and utilize the combined decryption key to decrypt the encrypted data.

Another aspect relates to an electronic device comprising a processor; memory; an electronic display; storage comprising an application configured to authorize a user based on input login credentials, prompt a user via the electronic display for temporary authorization credentials, store input temporary authorization credentials, subsequently re-authenticate a user by prompting the user via the electronic display for temporary authorization credentials and comparing newly input temporary authorization credentials to the stored temporary authorization credentials.

Another aspect relates to a system comprising means for first, receiving, from a user via one or more input devices associated with an electronic device, user input corresponding to authorization credentials for an electronic system; communicating, from the user device to an authentication service for the electronic system, authentication information for the user based on the input authorization credentials; determining, by the authentication service based on the received authentication information, that the user is an authorized user, and based thereon returning an authorization token to the user device; receiving, at the user device, the original authorization token, and based thereon storing the received original authorization token at the user device and displaying, to the user via a display associated with the electronic device, an interface soliciting entry of a session passcode; receiving, at the user device from the user via one or more input devices associated with the electronic device, user input corresponding to entry of a session passcode; integrating a hash of the session passcode into the authentication token, and storing, by the authentication service in a secure data store, the authentication token including the hash of the session passcode integrated therein. The system further comprises means for thereafter, determining that an event has occurred requiring re-authentication of the user; based on the determination that an event has occurred requiring re-authentication of the user, displaying, to the user via a display associated with the electronic device, an interface soliciting entry of the session passcode; receiving, at the user device from the user via one or more input devices associated with the electronic device, user input corresponding to entry of a suspect session passcode; integrating a hash of the suspect session passcode into the original authentication token; comparing, by the authentication service, the received authentication token including the hash of the suspect session passcode integrated therein to the stored authentication token including the hash of the session passcode integrated therein and determining that they match; based on the determination that they match, communicating, by the authentication service, a re-authentication indication to the electronic device; and receiving, at the electronic device, the communicated re-authentication indication, and, based thereon, allowing the user continued access to the electronic system.

Another aspect relates to a system comprising means for first, receiving, from a user via one or more input devices associated with an electronic device, user input corresponding to full authorization credentials for an electronic system; communicating, from the user device to the electronic system, authentication information for the user based on the input full authorization credentials; determining, by the electronic system based on the received authentication information, that the user is an authorized user, and based thereon returning an authentication indication to the user device; receiving, at the user device, the authentication indication, and based thereon, displaying, to the user via a display associated with the electronic device, an interface soliciting entry or selection of temporary authentication credentials; receiving, at the user device from the user via one or more input devices associated with the electronic device, user input corresponding to entry or selection of temporary authorization credentials; communicating, from the electronic device to the electronic system, an indication of the temporary authorization credentials; storing, by the electronic system at a secure database associated with the electronic system, data corresponding to the temporary authorization credentials. The system further comprises means for thereafter, determining that an event has occurred requiring re-authentication; based on the determination that an event has occurred requiring re-authentication, displaying, to the user via a display associated with the electronic device, an interface soliciting entry of the temporary authorization credentials; receiving, at the user device from the user via one or more input devices associated with the electronic device, user input corresponding to entry of suspect temporary authorization credentials; communicating, from the electronic device to the electronic system, an indication of the suspect temporary authorization credentials; comparing, by the electronic system, data corresponding to the suspect temporary authorization credentials to the stored data corresponding to the temporary authorization credentials and determining that they match; based on the determination that they match, communicating, by the electronic system, a re-authentication indication to the electronic device; and receiving, at the electronic device, the communicated re-authentication indication, and, based thereon, allowing the user continued access to the electronic system.

Another aspect relates to a method comprising first, a step for receiving, from a user via one or more input devices associated with an electronic device, user input corresponding to authorization credentials for an electronic system; a step for communicating, from the user device to an authentication service for the electronic system, authentication information for the user based on the input authorization credentials; a step for determining, by the authentication service based on the received authentication information, that the user is an authorized user, and based thereon returning an authorization token to the user device; a step for receiving, at the user device, the original authorization token, and based thereon storing the received original authorization token at the user device and displaying, to the user via a display associated with the electronic device, an interface soliciting entry of a session passcode; a step for receiving, at the user device from the user via one or more input devices associated with the electronic device, user input corresponding to entry of a session passcode; a step for integrating a hash of the session passcode into the authentication token, and storing, by the authentication service in a secure data store, the authentication token including the hash of the session passcode integrated therein. The method further comprises, thereafter, a step for determining that an event has occurred requiring re-authentication of the user; a step for based on the determination that an event has occurred requiring re-authentication of the user, displaying, to the user via a display associated with the electronic device, an interface soliciting entry of the session passcode; a step for receiving, at the user device from the user via one or more input devices associated with the electronic device, user input corresponding to entry of a suspect session passcode; a step for integrating a hash of the suspect session passcode into the original authentication token; a step for comparing, by the authentication service, the received authentication token including the hash of the suspect session passcode integrated therein to the stored authentication token including the hash of the session passcode integrated therein and determining that they match; a step for based on the determination that they match, communicating, by the authentication service, a re-authentication indication to the electronic device; and a step for receiving, at the electronic device, the communicated re-authentication indication, and, based thereon, allowing the user continued access to the electronic system.

Another aspect relates to a method comprising first, a step for receiving, from a user via one or more input devices associated with an electronic device, user input corresponding to full authorization credentials for an electronic system; a step for communicating, from the user device to the electronic system, authentication information for the user based on the input full authorization credentials; a step for determining, by the electronic system based on the received authentication information, that the user is an authorized user, and based thereon returning an authentication indication to the user device; a step for receiving, at the user device, the authentication indication, and based thereon, displaying, to the user via a display associated with the electronic device, an interface soliciting entry or selection of temporary authentication credentials; a step for receiving, at the user device from the user via one or more input devices associated with the electronic device, user input corresponding to entry or selection of temporary authorization credentials; a step for communicating, from the electronic device to the electronic system, an indication of the temporary authorization credentials; a step for storing, by the electronic system at a secure database associated with the electronic system, data corresponding to the temporary authorization credentials. The method further comprises, thereafter, a step for determining that an event has occurred requiring re-authentication; a step for based on the determination that an event has occurred requiring re-authentication, displaying, to the user via a display associated with the electronic device, an interface soliciting entry of the temporary authorization credentials; a step for receiving, at the user device from the user via one or more input devices associated with the electronic device, user input corresponding to entry of suspect temporary authorization credentials; a step for communicating, from the electronic device to the electronic system, an indication of the suspect temporary authorization credentials; a step for comparing, by the electronic system, data corresponding to the suspect temporary authorization credentials to the stored data corresponding to the temporary authorization credentials and determining that they match; a step for based on the determination that they match, communicating, by the electronic system, a re-authentication indication to the electronic device; and a step for receiving, at the electronic device, the communicated re-authentication indication, and, based thereon, allowing the user continued access to the electronic system.

Another aspect relates to a method comprising first, receiving, from a user via one or more input devices associated with an electronic device, user input corresponding to full authorization credentials; determining, based on the received full authorization credentials, that the user is an authorized user, and based thereon displaying, to the user via a display associated with the electronic device, an interface soliciting entry or selection of temporary authentication credentials; receiving, at the user device from the user via one or more input devices associated with the electronic device, user input corresponding to entry or selection of temporary authorization credentials; and securely storing data corresponding to the temporary authorization credentials. The method further comprises, thereafter, determining that an event has occurred requiring re-authentication of the user; based on the determination that an event has occurred requiring re-authentication, displaying, to the user via a display associated with the electronic device, an interface soliciting entry of the temporary authorization credentials; receiving, at the user device from the user via one or more input devices associated with the electronic device, user input corresponding to entry of suspect temporary authorization credentials; electronically comparing data corresponding to the suspect temporary authorization credentials to the stored data corresponding to the temporary authorization credentials and determining that they match; and based on the determination that they match, re-authenticating the user.

Another aspect relates to one or more computer readable media containing computer executable instructions for performing a disclosed method.

Another aspect relates to a system for performing a disclosed method.

Another aspect relates to a disclosed method.

Another aspect relates to a system comprising an electronic device and electronic access system configured to perform a disclosed method.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals.

FIGS. 1-7 illustrate an exemplary methodology in accordance with one or more preferred implementations.

FIG. 8 illustrates an exemplary interface for accessing a system in accordance with one or more preferred implementations.

FIGS. 9-12 illustrate an exemplary methodology in accordance with one or more preferred implementations in which a user is required to re-authenticate utilizing a user-created session passcode upon attempting to access more secure information.

FIGS. 13-14 illustrate an exemplary methodology in accordance with one or more preferred implementations in which a user is required to re-authenticate utilizing a user-created session passcode following a period of inactivity or upon elapsing of an amount of time since login or the last re-authentication.

FIGS. 15-17 illustrate an exemplary methodology in accordance with one or more preferred implementations in which a session passcode is utilized in combination with an authorization token.

FIGS. 18-19 illustrate an exemplary methodology in which a user is required to re-authenticate utilizing a user-created session passcode.

FIGS. 20-28 illustrates functionality in accordance with one or more preferred implementations.

FIG. 29 illustrates a system comprising a phone.

FIG. 30 illustrates a system comprising a laptop.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or any combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. § 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “a” and “an” each generally denotes “at least one”, but does not exclude a plurality unless the contextual use dictates otherwise. Thus, reference to “a picnic basket having an apple” describes “a picnic basket having at least one apple” as well as “a picnic basket having apples”. In contrast, reference to “a picnic basket having a single apple” describes “a picnic basket having only one apple”.

When used herein to join a list of items, “or” denotes “at least one of the items”, but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”. When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”.

Referring now to the drawings, one or more preferred embodiments of the invention are next described. The following description of one or more preferred embodiments is merely exemplary in nature and is in no way intended to limit the invention, its implementations, or uses.

In accordance with one or more preferred implementations, a method involves use of a dynamic or session limited passcode that is generated by a user at the time of initial authentication on access to an electronic system or platform. This differs from other dynamic authentication systems in that it is generated by the user as opposed to by a computer system. As it expires after a limited time, it is not prone to a variety of attacks and the user only has to recall the passcode that they self-generated for the duration of the session. This methodology can be used on top of any other authentication layer on initial access. In accordance with various preferred implementations, initial access to the system can be of any complexity with the last stage being the user generation of a passcode. This dynamic passcode does not lead to any improved initial authentication, however it does lead to an ongoing and easy to use one session only authentication that can be used to prevent total system time out (as discussed hereinabove) and also can be used to re-authenticate a user for access to more sensitive areas of a system (as discussed hereinabove). In accordance with one or more preferred implementations, a dynamic user generated passcode can be of variable complexity depending on the security requirements of a system. Furthermore, in accordance with one or more preferred implementations, every time there is a request for the previously inputted Session-Limited user generated Passcode (SLP) this can be logged by the system and used to audit access by that user to sensitive areas of the system.

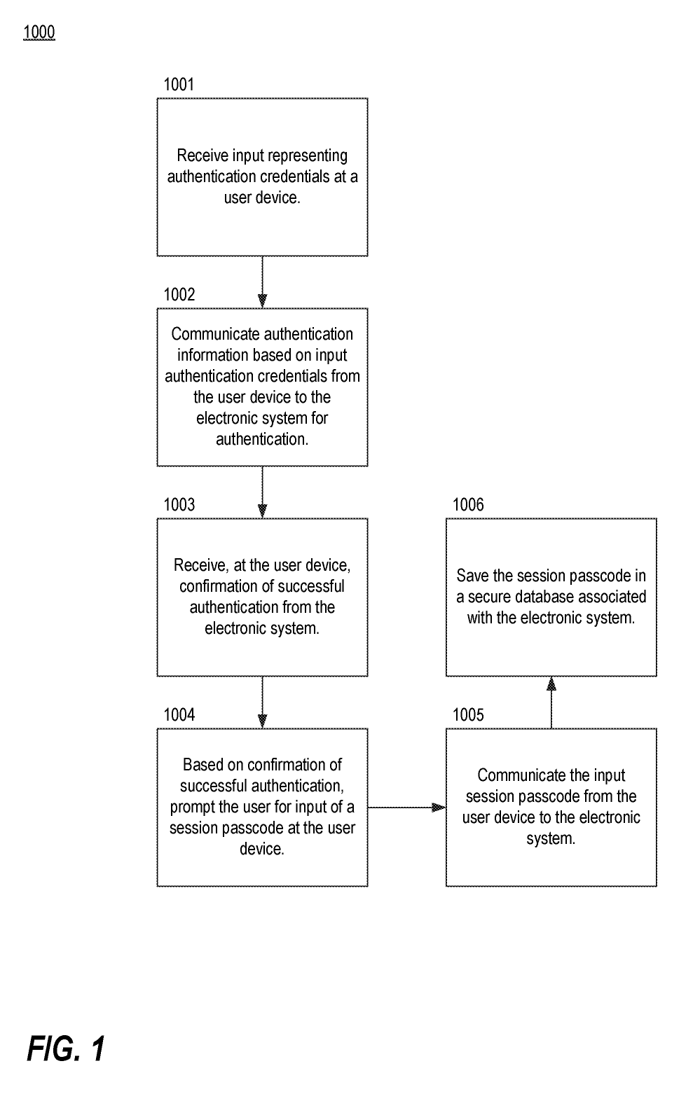

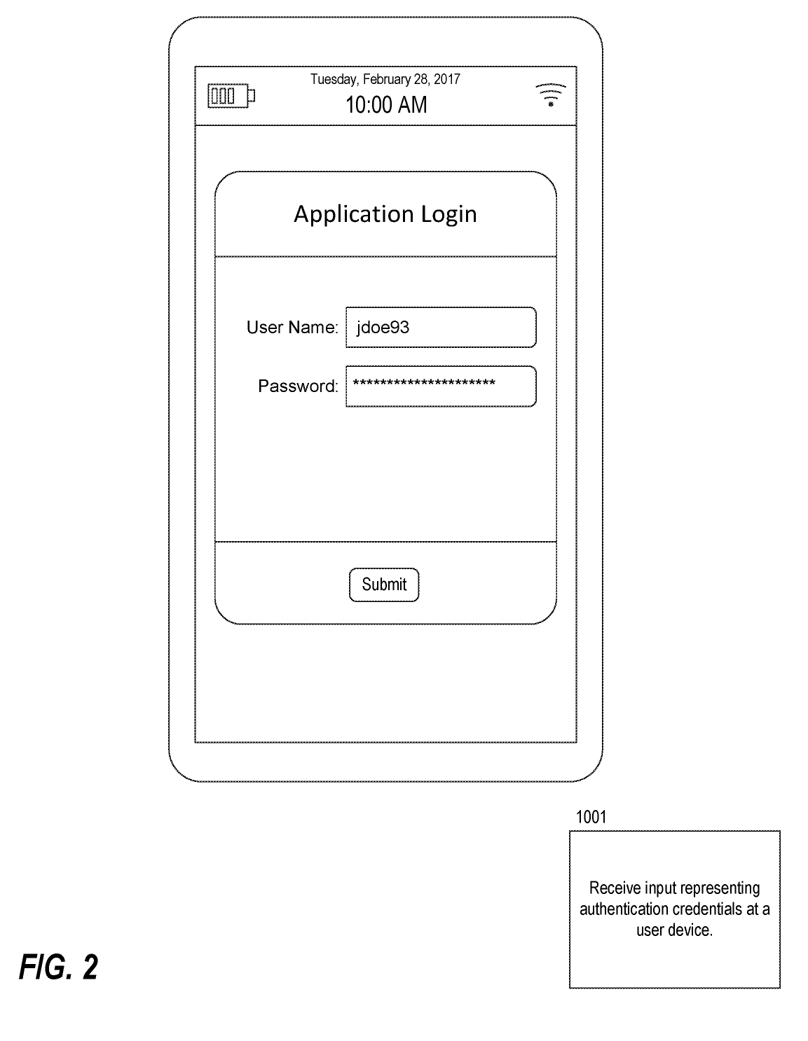

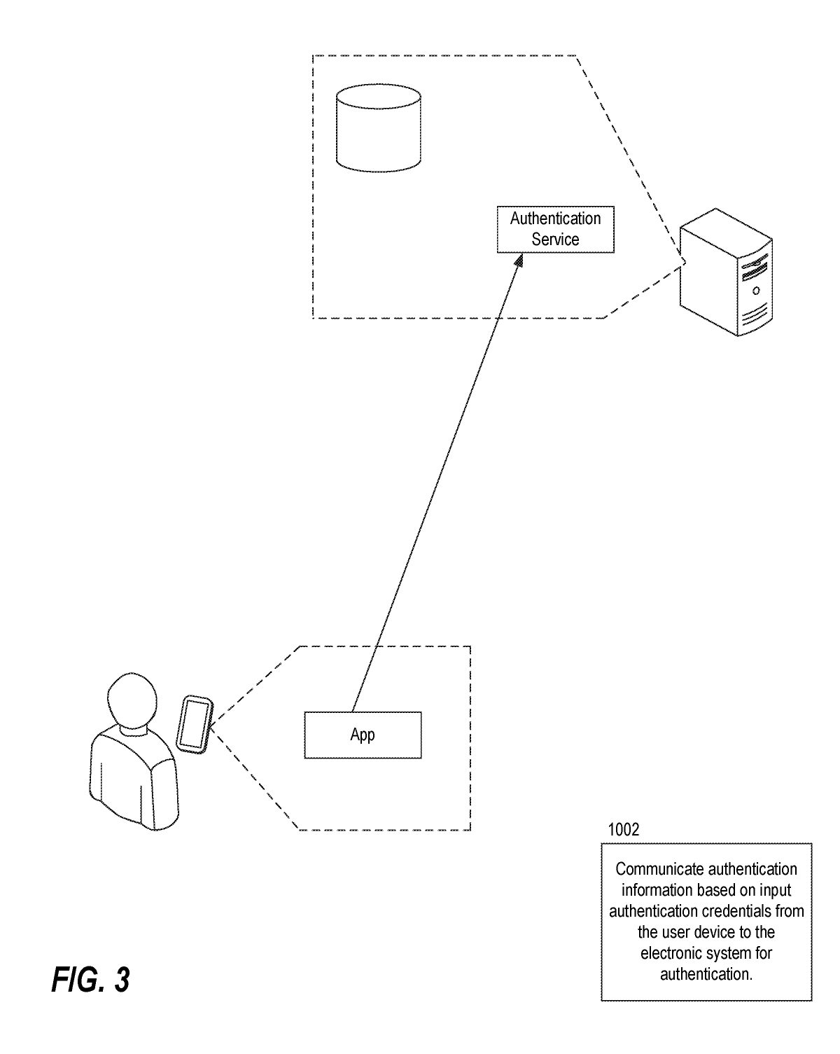

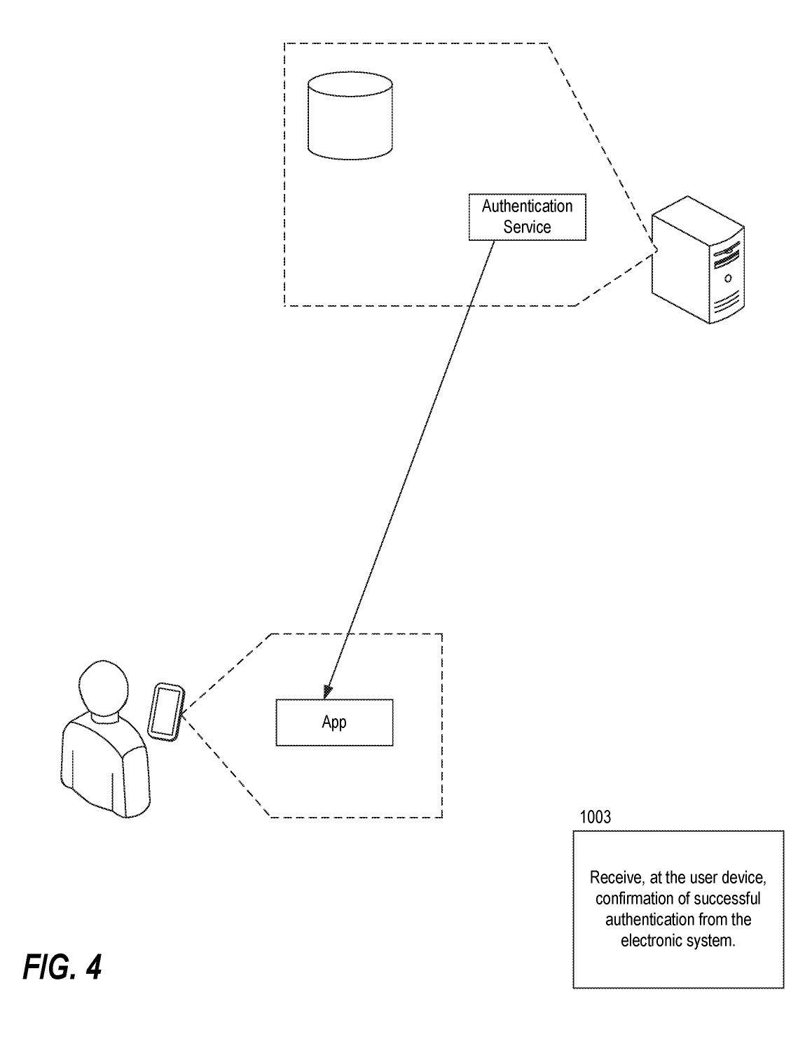

FIG. 1 illustrates an exemplary methodology 1000 in accordance with one or more preferred implementations. In accordance with the methodology 1000, user input representing authentication credentials is first received at a user device at step 1001, as illustrated in FIG. 2. At step 1002, authentication information based on the input authentication credentials is communicated from the user device to an authentication service for an electronic system, as illustrated in FIG. 3. The authentication service utilizes the received authentication information to authenticate the user of the user device, and, assuming authentication is successful, communicates confirmation of authentication back to the user device, and the user device receives this confirmation at step 1003, as illustrated in FIG. 4.

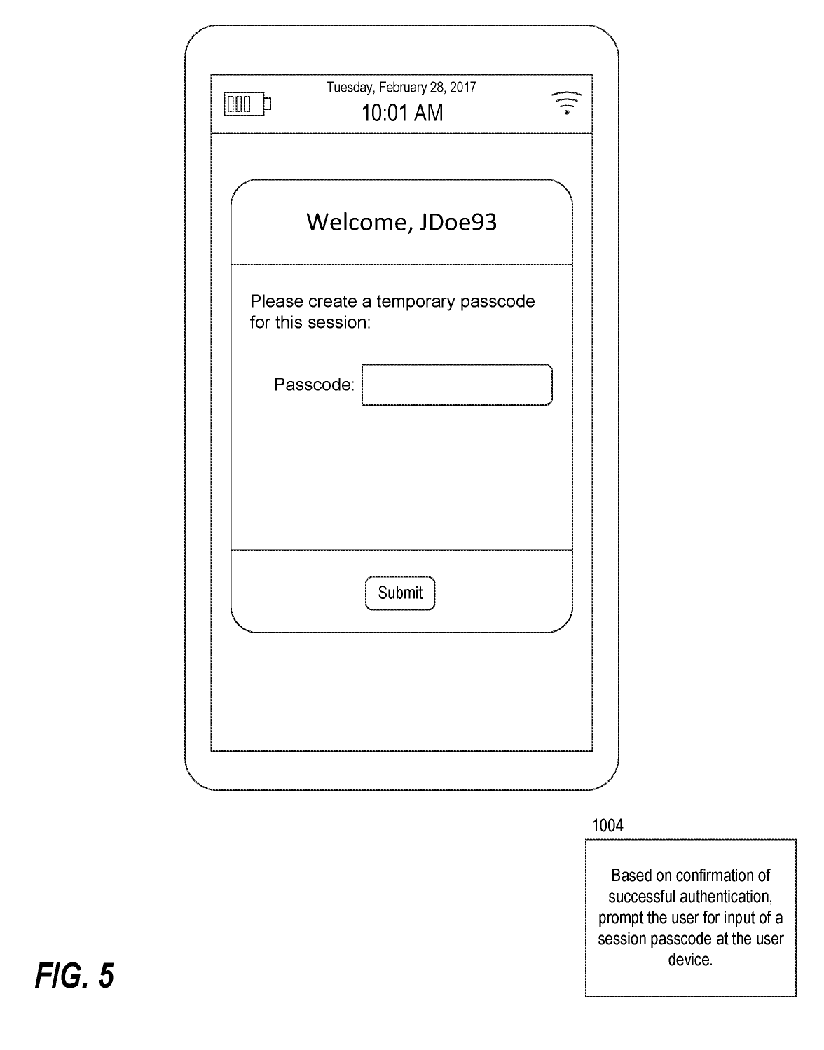

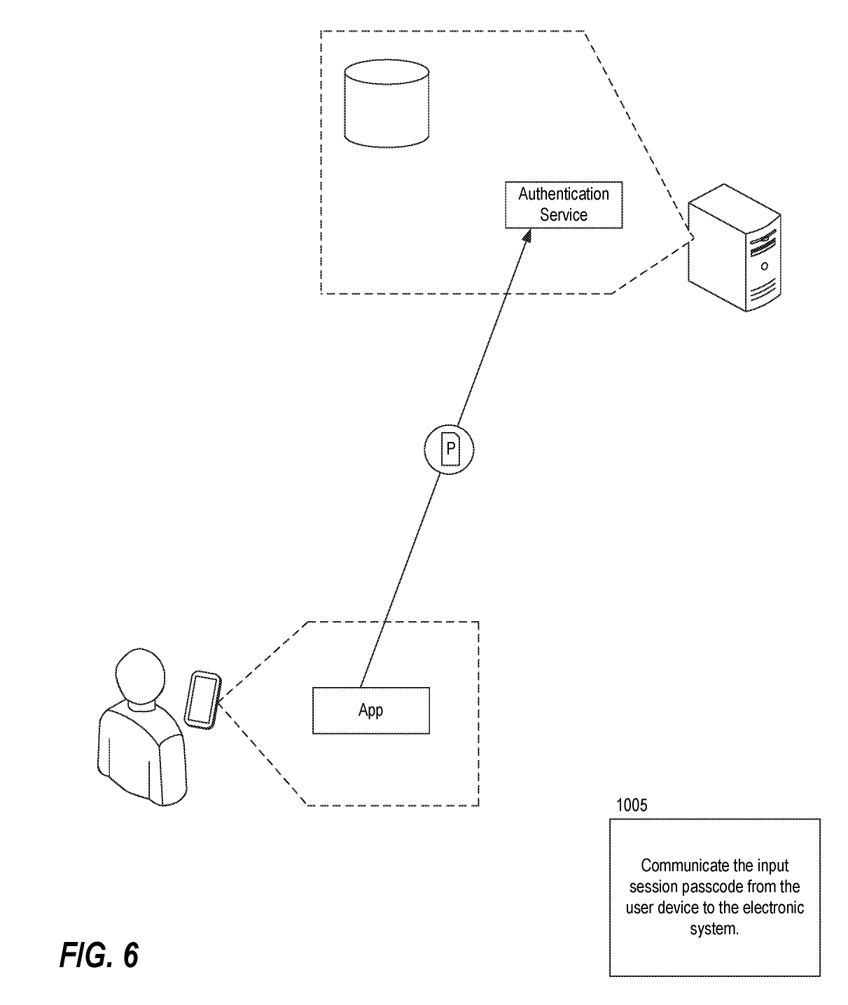

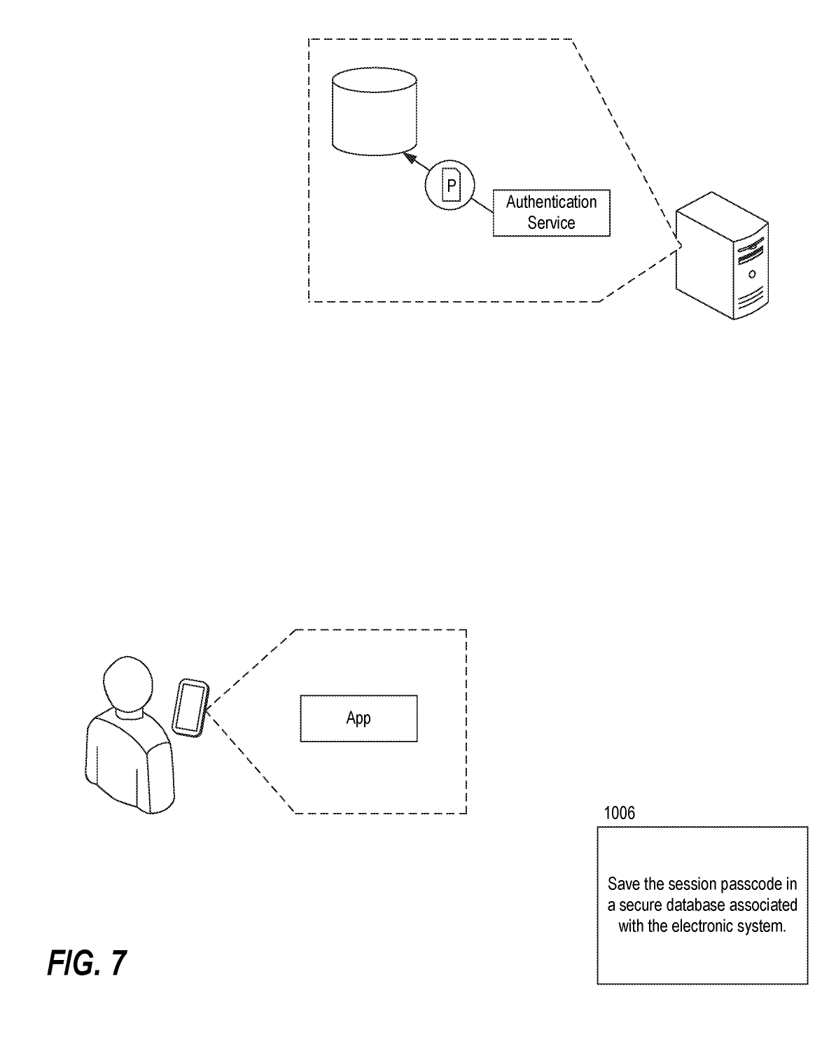

In accordance with one or more preferred implementations, at step 1004, based on receipt of confirmation of successful authentication, the user is prompted to input a session passcode, as illustrated in FIG. 5. At step 1005, this input session passcode is communicated to the electronic system, as illustrated in FIG. 6. At step 1006, the electronic system saves the input session passcode in a secure database, as illustrated in FIG. 7.

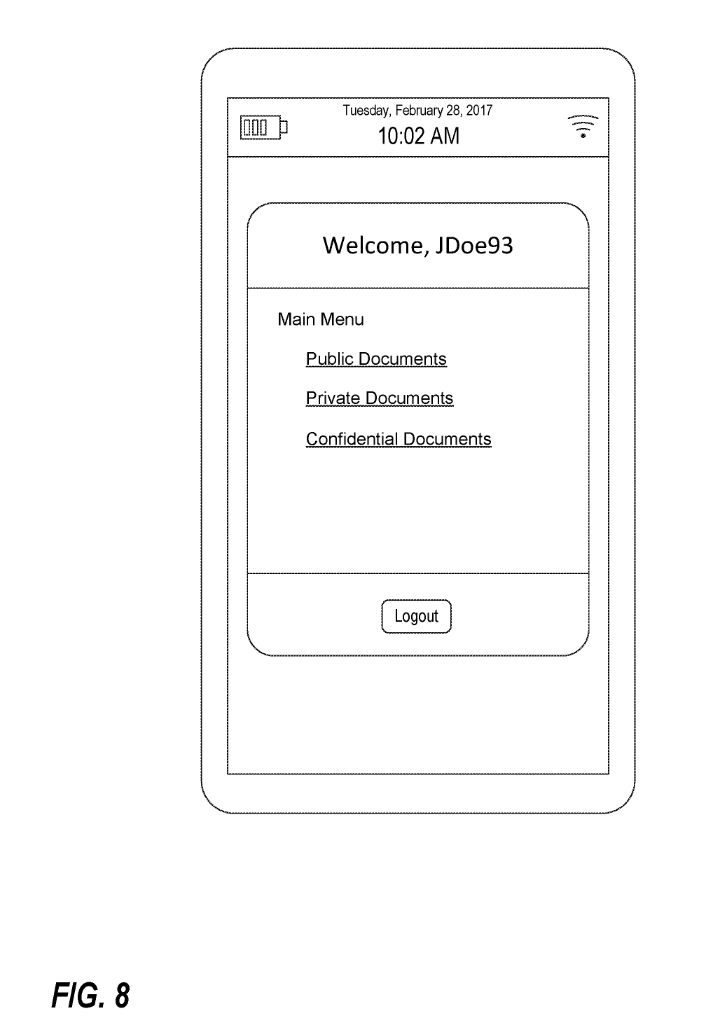

At this point, the user is authenticated to the system and can access system resources, as illustrated in FIG. 8.

In accordance with one or more preferred implementations, the user generated session passcode can subsequently be utilized for rapid re-authentication of the user during the session. For example, if the user desires to access a particular secure part of an application or particularly secure resource, e.g., confidential documents, the user can be prompted to re-authenticate him or herself by inputting the session passcode. This allows for re-authentication of the user without having to re-input the original authentication credentials.

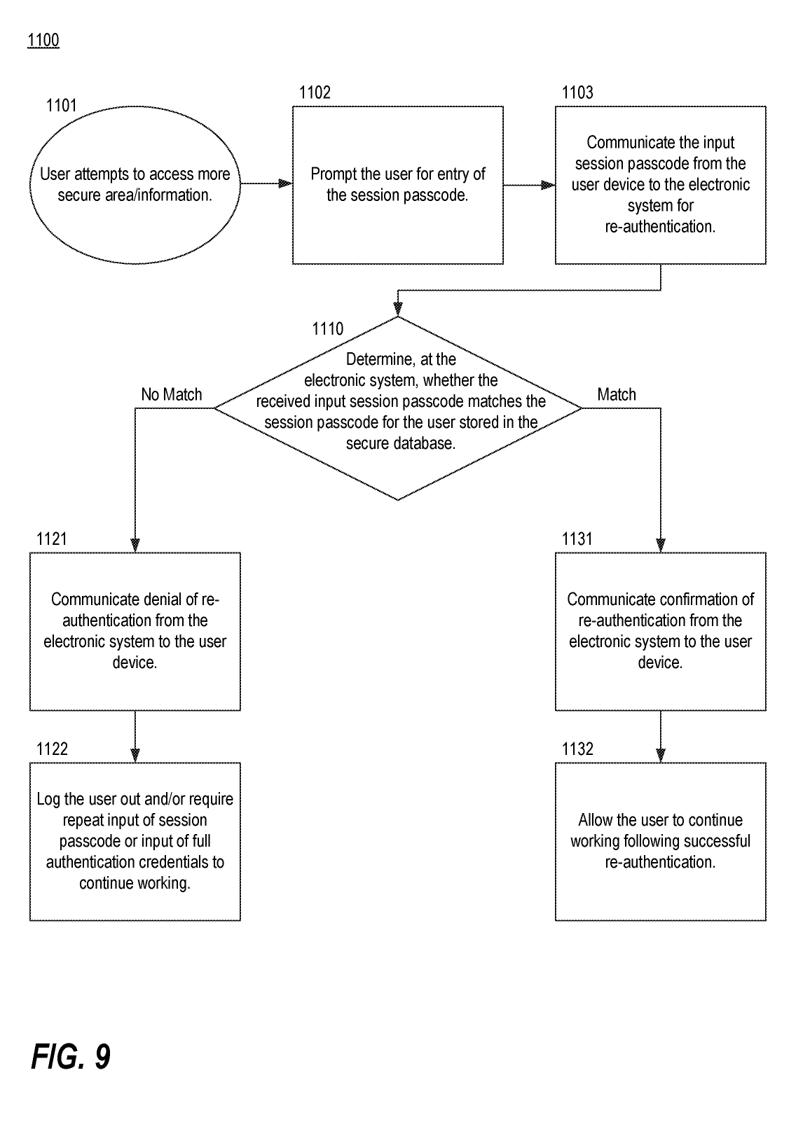

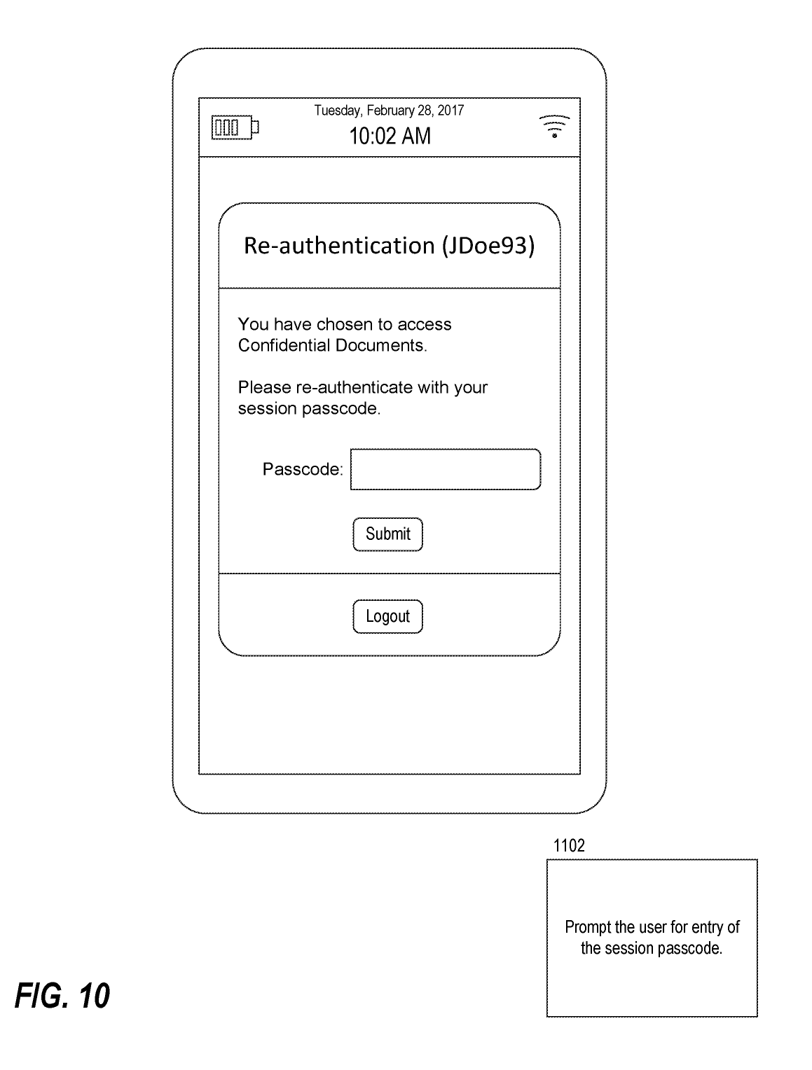

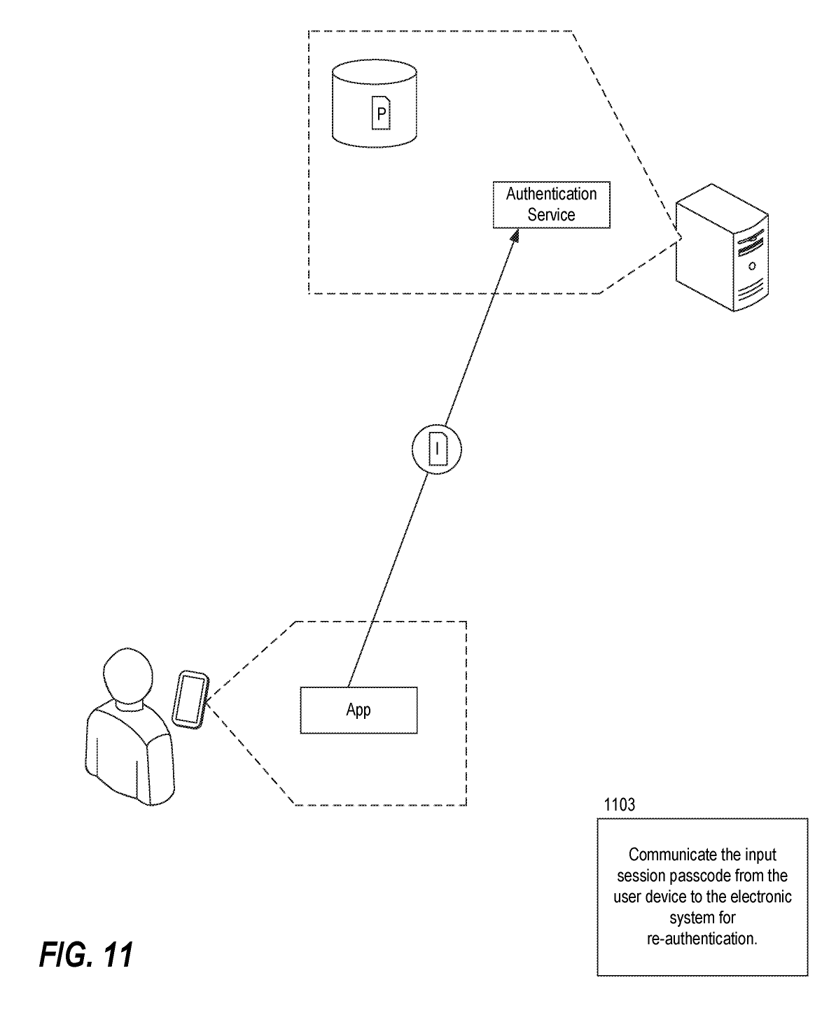

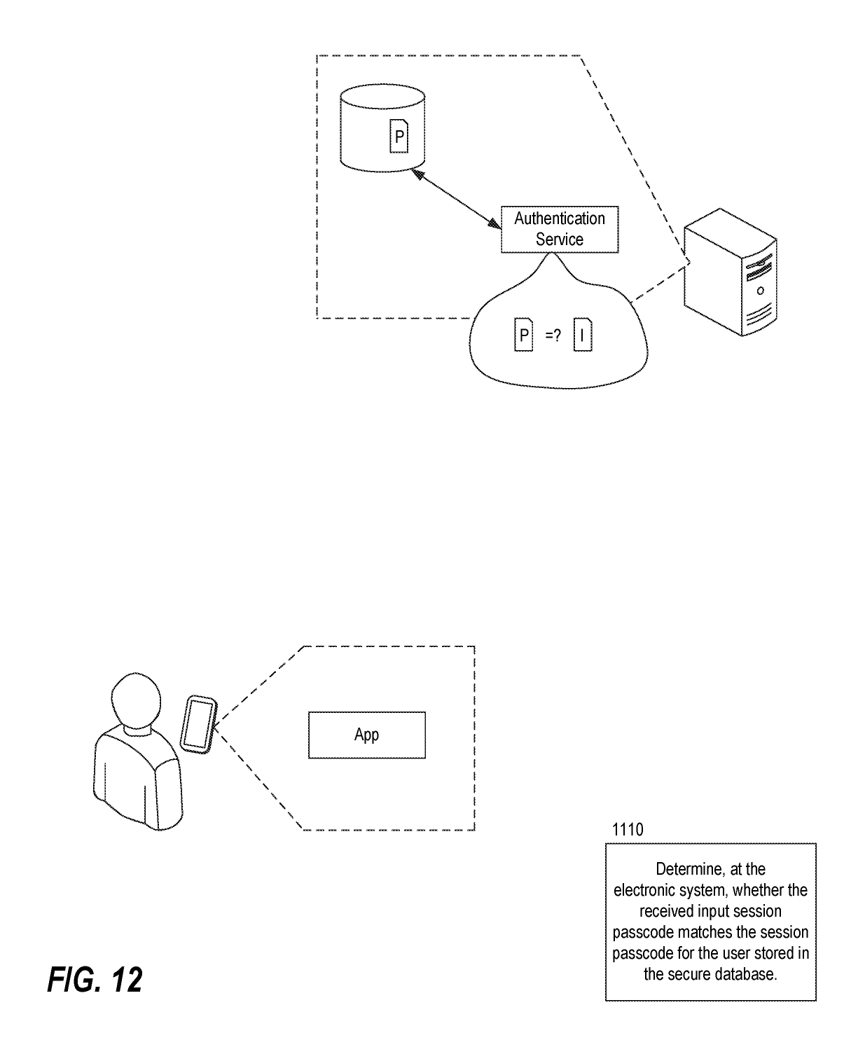

FIG. 9 illustrates an exemplary methodology 1100 in accordance with one or more preferred implementations in which a user is required to re-authenticate utilizing the user-created session passcode upon attempting to access more secure information. In response to attempting to access more secure information (step 1101), at step 1102, the user is prompted for entry of the session passcode, as illustrated in FIG. 10. At step 1103, the input session passcode is communicated from the user device to the electronic system for re-authentication, as illustrated in FIG. 11. Next, at step 1110, the electronic system determines whether the received input session passcode is valid for re-authentication of the user. In accordance with one or more preferred implementations this involve a direct comparison of the received input session passcode to a stored session passcode, as illustrated further in FIG. 12, while in accordance with one or more preferred implementations this involves another type of comparison, such as, for example, a comparison of a hash of received input session passcode to a stored hash for a session passcode.

If it is determined that re-authentication is not successful, then at step 1121 an indication of this is communicated from the electronic system to the user device, and at step 1122 the user is logged out and/or prompted to re-enter their session passcode and/or full authentication credentials.

If, on the other hand, it is determined that re-authentication is successful, then at step 1131 confirmation of re-authentication is communicated from the electronic system to the user device and at step 1132 the user is allowed to continue working.

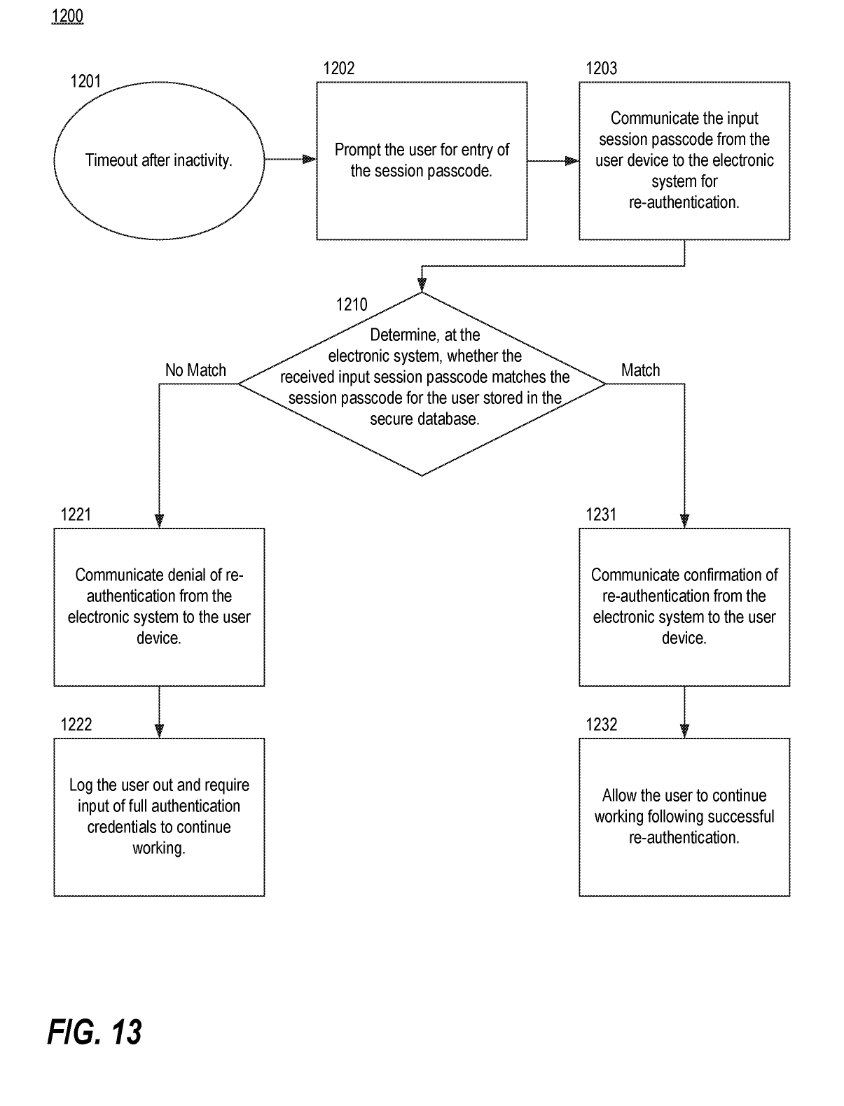

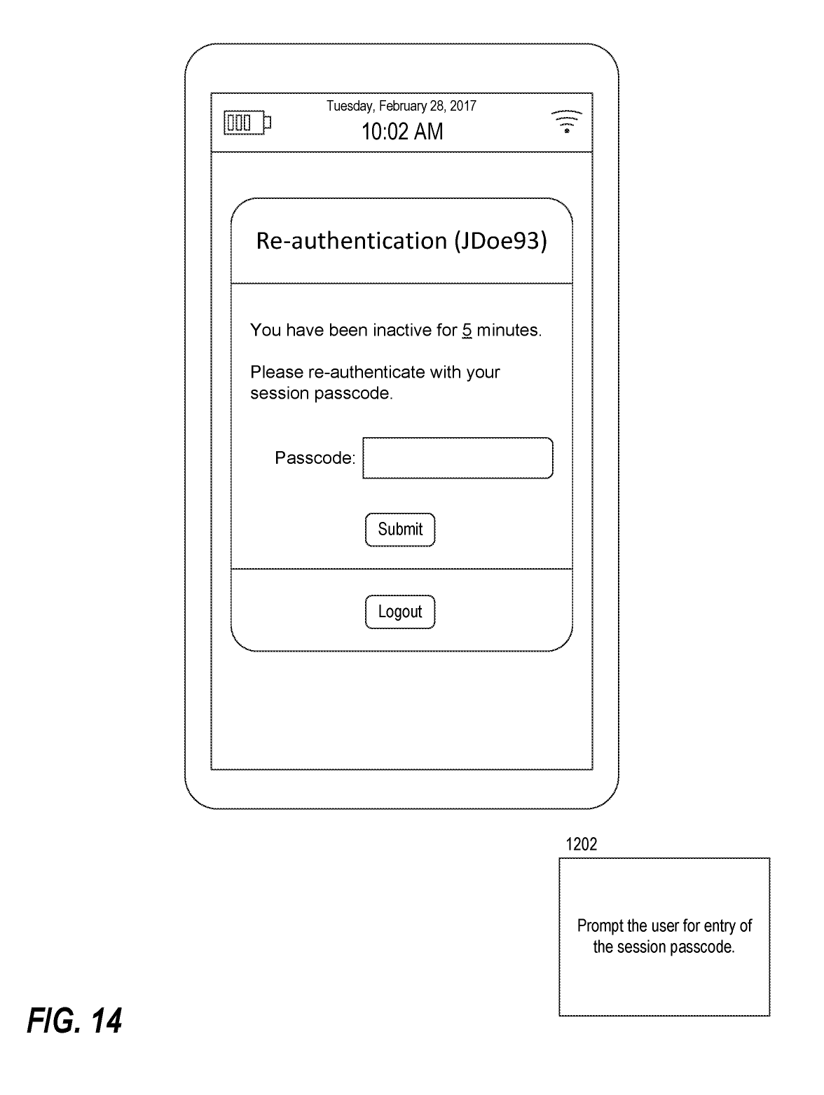

FIG. 13 illustrates a similar exemplary methodology 1200 in accordance with one or more preferred implementations in which a user is required to re-authenticate utilizing the user-created session passcode following a period of inactivity or upon elapsing of an amount of time since login or the last re-authentication (step 1201). Based on this, at step 1202, the user is prompted for entry of the session passcode, as illustrated in FIG. 14.

At step 1203, the input session passcode is communicated from the user device to the electronic system for re-authentication. Next, the electronic system determines whether the received input session passcode is valid for re-authentication of the user. In accordance with one or more preferred implementations, this involve a direct comparison of the received input session passcode to a stored session passcode, as exemplified by step 1210, while in accordance with one or more preferred implementations this involves another type of comparison, such as, for example, a comparison of a hash of received input session passcode to a stored hash for a session passcode.

If it is determined that re-authentication is not successful, then at step 1221 an indication of this is communicated from the electronic system to the user device, and at step 1222 the user is logged out and/or prompted to re-enter their session passcode and/or full authentication credentials.

If, on the other hand, it is determined that re-authentication is successful, then at step 1231 confirmation of re-authentication is communicated from the electronic system to the user device and at step 1232 the user is allowed to continue working.

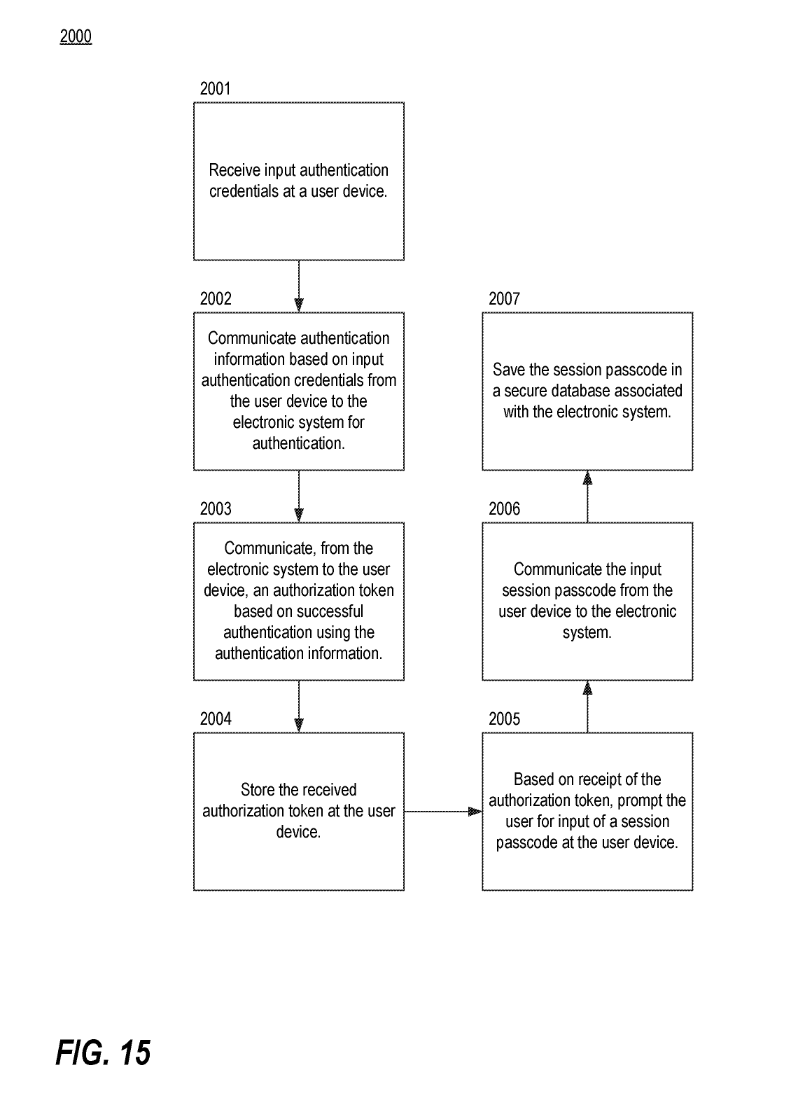

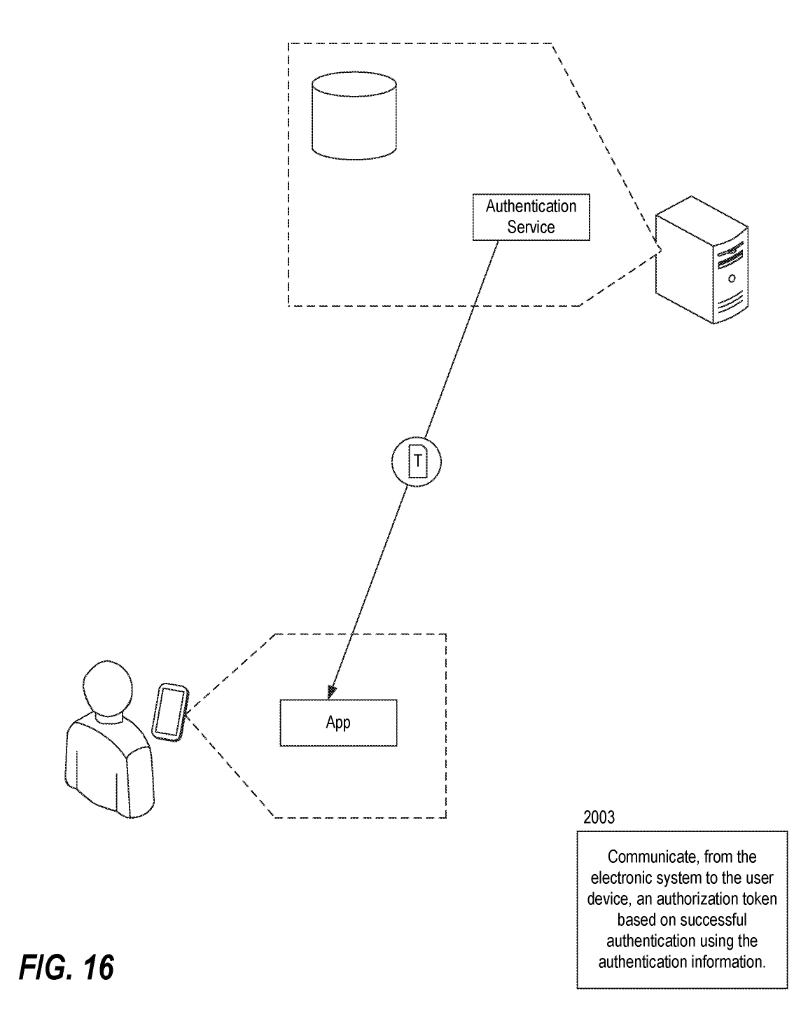

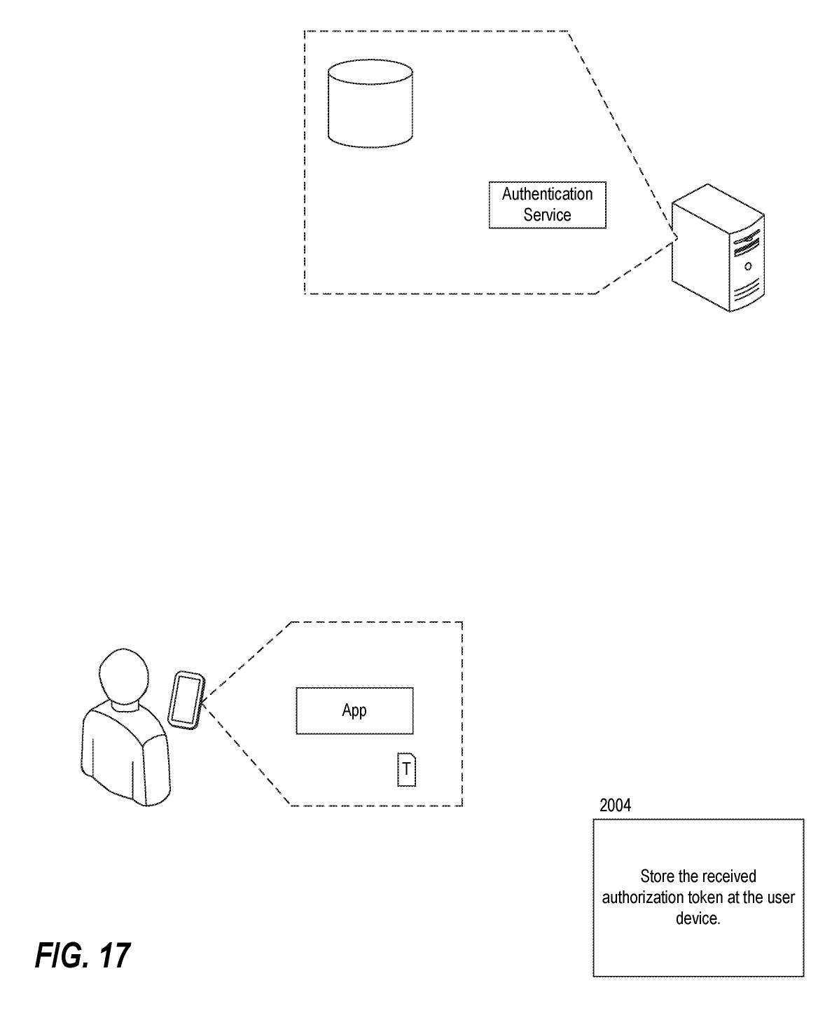

FIG. 15 illustrates an exemplary methodology 2000 in accordance with one or more preferred implementations in which a session passcode is utilized in combination with an authorization token, such as an OAuth authorization token. In accordance with the methodology 2000, user input representing authentication credentials is first received at a user device at step 2001. At step 2002, authentication information based on the input authentication credentials is communicated from the user device to an electronic system for an authorization service. The authentication service utilizes the received authentication information to authenticate the user of the user device, and, assuming authentication is successful, communicates an authorization token back to the user device at step 2003, as illustrated in FIG. 16. The user device receives this authorization token and, at step 2004, stores the received authorization token at the user device, as illustrated in FIG. 17.

In accordance with one or more preferred implementations, at step 2005, based on receipt of confirmation of successful authentication, the user is prompted to input a session passcode. At step 2006, this input session passcode is communicated to the electronic system. At step 2007, the electronic system saves the input session passcode in a secure database.

At this point, the user is authenticated to the system and can access system resources.

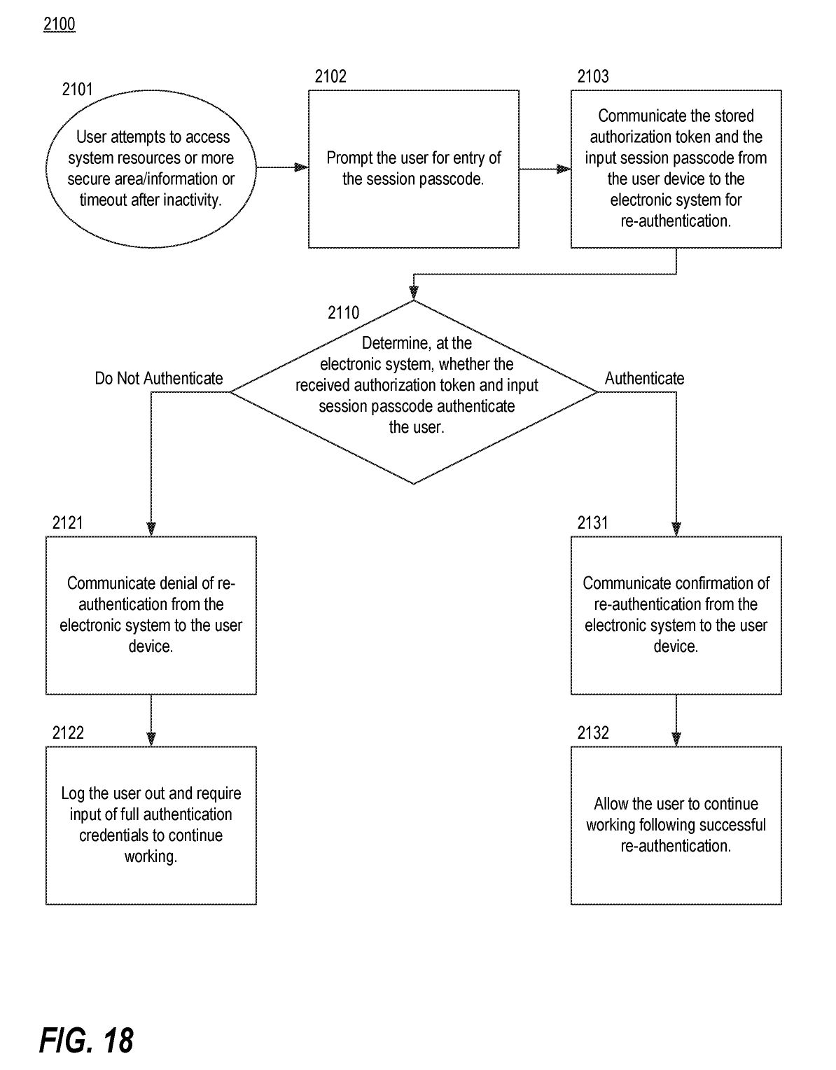

In accordance with one or more preferred implementations, subsequently, when a user wishes to access electronic system resources, either after a period of inactivity, upon wishing to access more secure resources, or possibly every time access to system resources is desired, the user is prompted to enter the session passcode which is utilized in combination with the stored authorization token to re-authenticate for access. FIG. 18 illustrates an exemplary such methodology in which a user is required to re-authenticate utilizing a user-created session passcode.

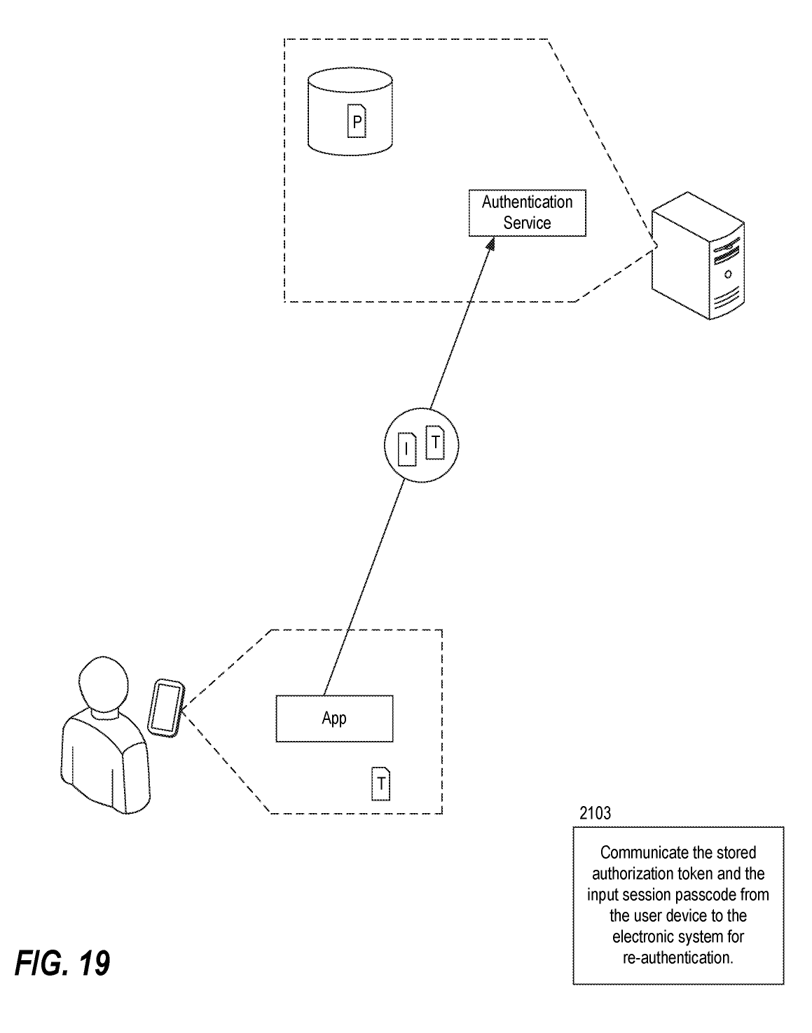

First, at step 2102, a user is prompted for entry of a session passcode. At step 2103, the input session passcode and the stored authorization token are communicated from the user device to the electronic system for re-authentication, as illustrated in FIG. 19. Next, at step 2110, the electronic system determines whether the received input session passcode and received authorization token are valid for re-authentication of the user.

If it is determined that re-authentication is not successful, then at step 2121 an indication of this is communicated from the electronic system to the user device, and at step 2122 the user is logged out and/or prompted to re-enter their session passcode and/or full authentication credentials.

If, on the other hand, it is determined that re-authentication is successful, then at step 2131 confirmation of re-authentication is communicated from the electronic system to the user device and at step 2132 the user is allowed to continue working.

In accordance with one or more preferred implementations, a hash of a newly input session passcode is integrated into an authorization token and utilized for re-authentication of a user via comparison to an authorization token integrated with a hash of an originally input session passcode (e.g., a stored session passcode).

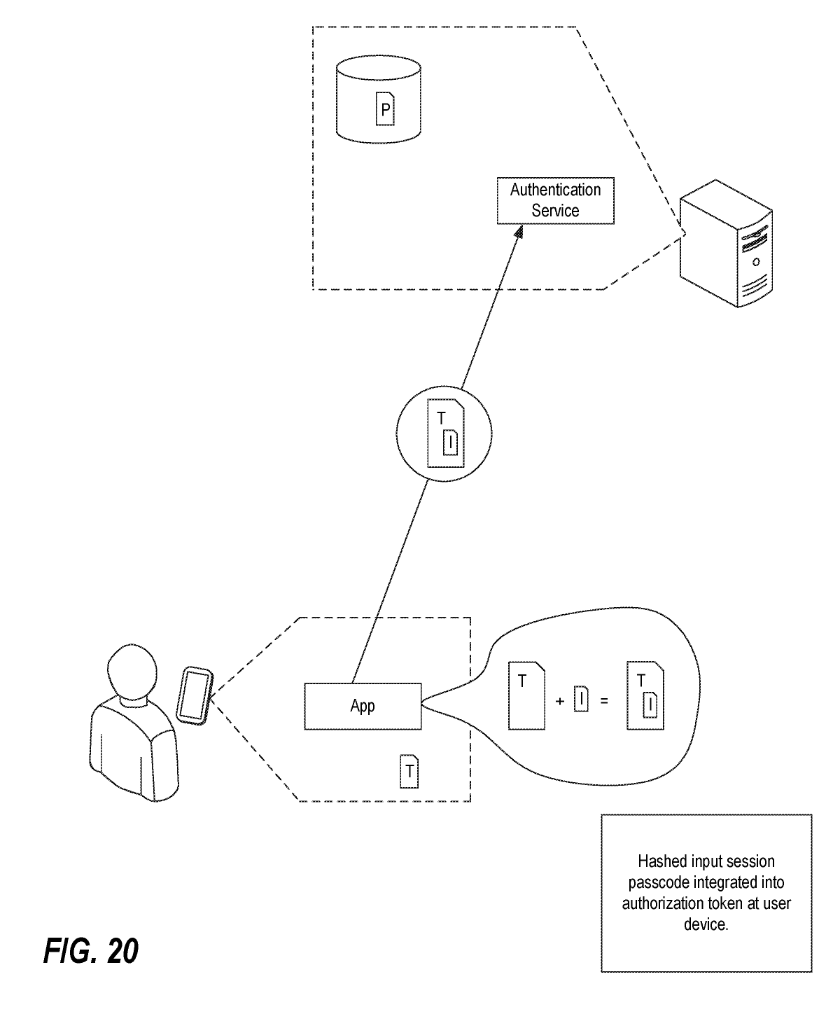

In accordance with one or more preferred implementations, when it is time to re-authenticate, a hash of a newly input session passcode is integrated into an authorization token at a user device, as illustrated in FIG. 20.

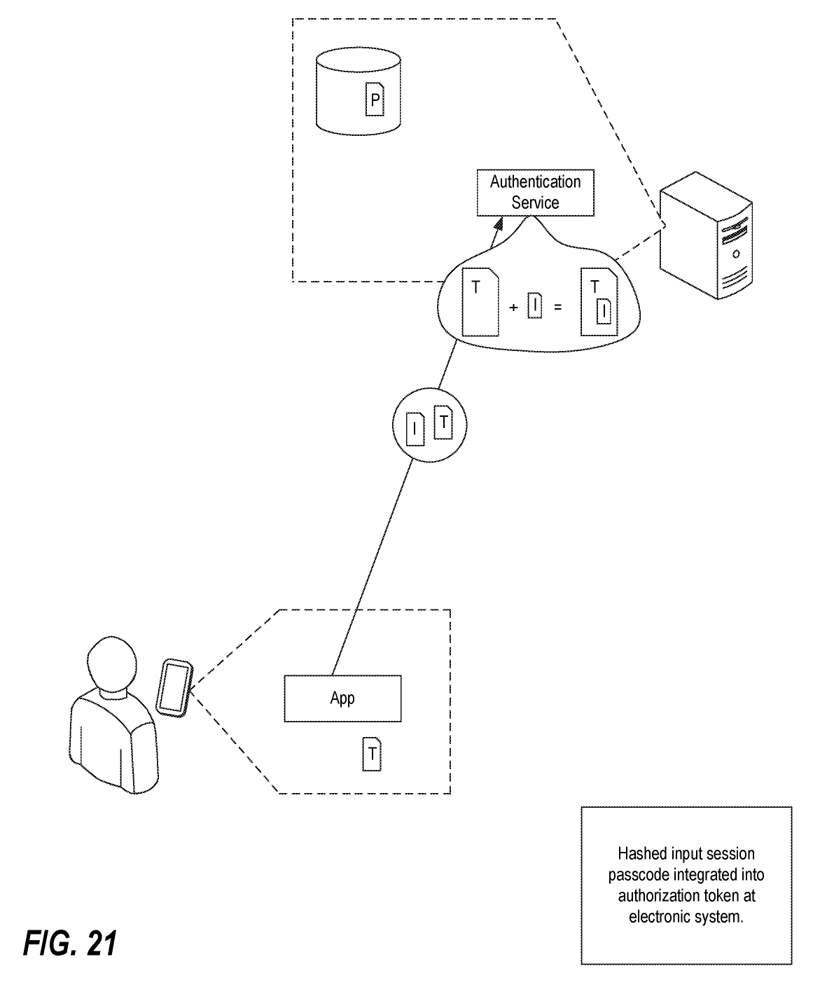

In accordance with one or more preferred implementations, when it is time to re-authenticate, a hash of a newly input session passcode is integrated into an authorization token at an electronic system, as illustrated in FIG. 21.

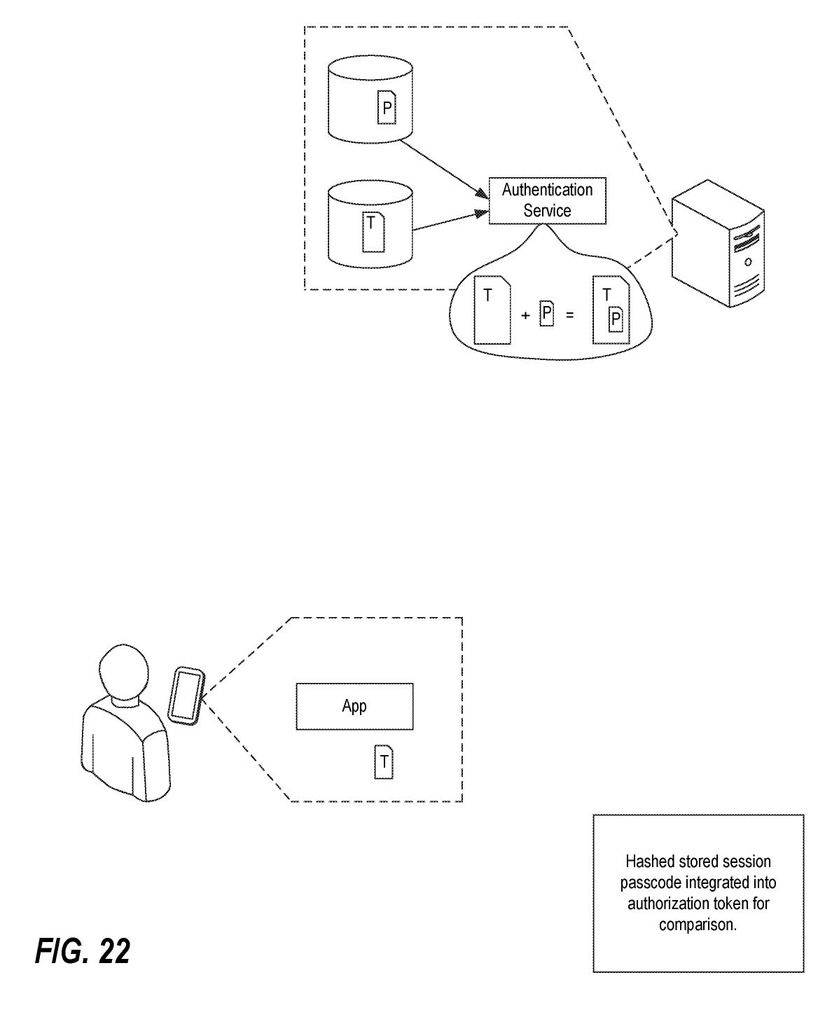

In accordance with one or more preferred implementations, when it is time to re-authenticate, a hash of a session passcode stored at an electronic system is integrated into an authorization token, as illustrated in FIG. 22. The session passcode may be stored in hashed form, and/or may be hashed immediately prior to integration into an authorization token.

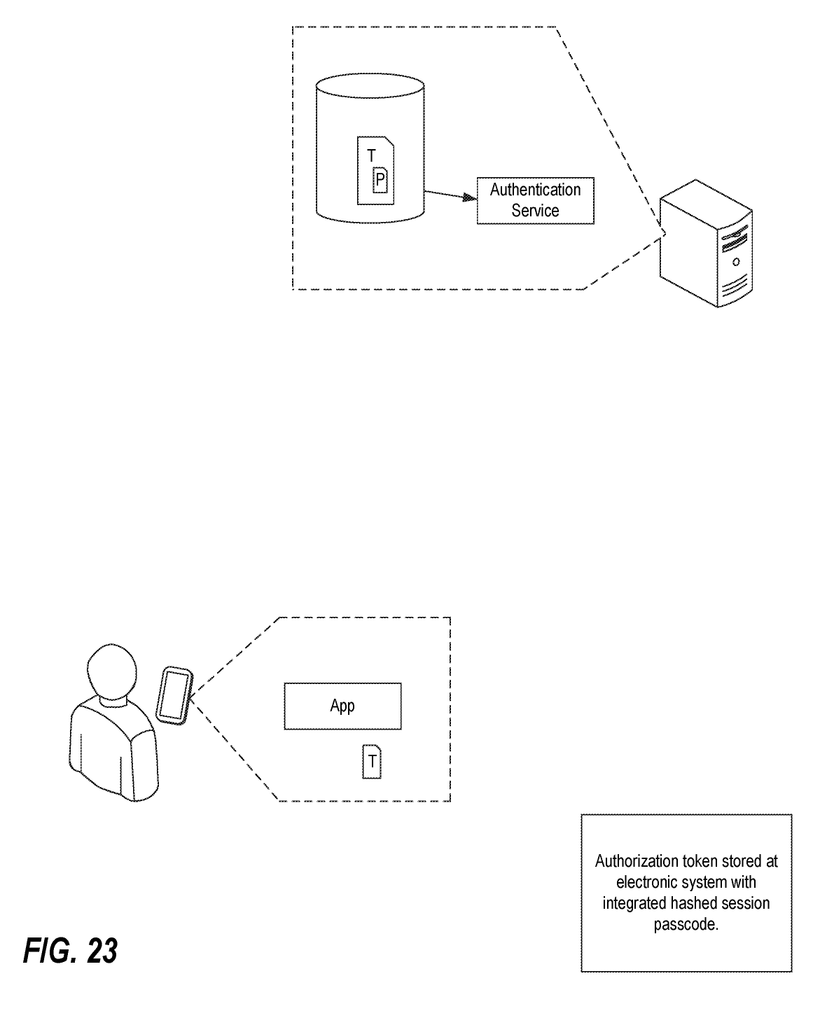

In accordance with one or more preferred implementations, an authorization token is stored at an electronic system with a hash of a session passcode integrated therein, as illustrated in FIG. 23.

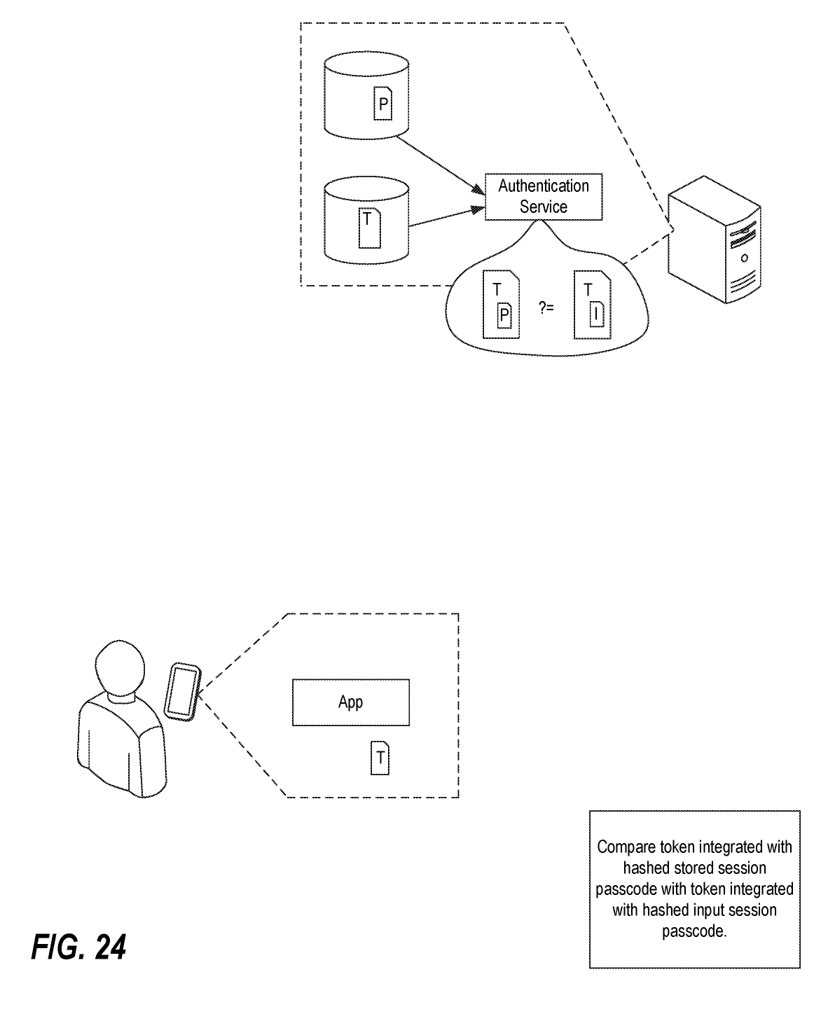

In accordance with one or more preferred implementations, an authorization token integrated with a hashed stored session passcode is compared to an authorization token integrated with a hashed newly input session passcode, as illustrated in FIG. 24.

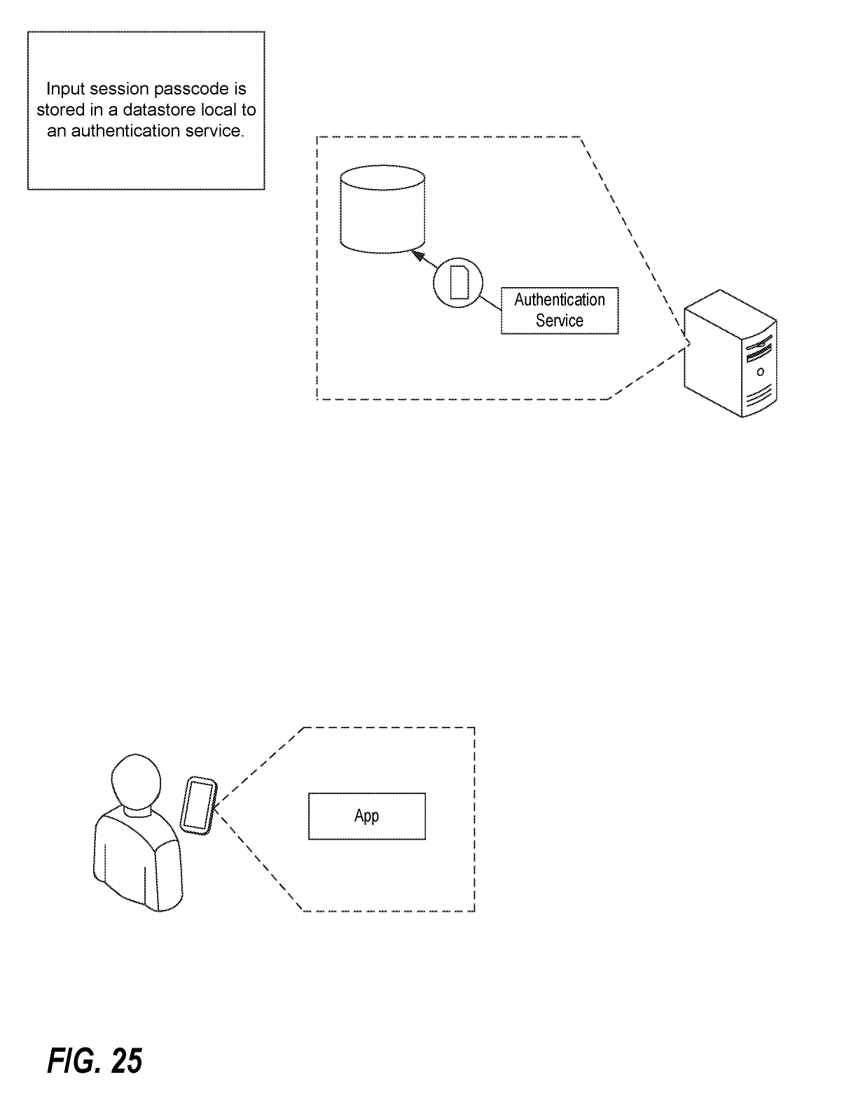

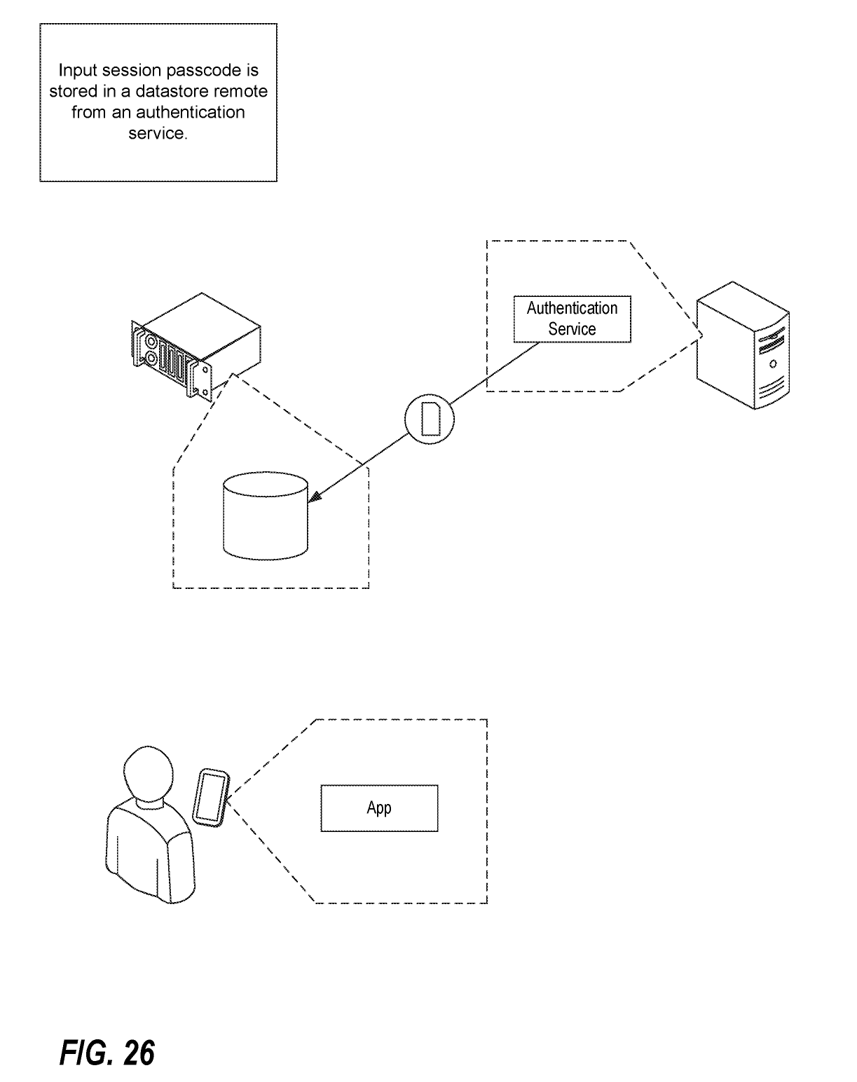

Although disclosure herein has largely illustrated an exemplary architecture in which an input session passcode is stored in a database local to an authentication service (as illustrated in FIG. 25), in accordance with one or more preferred implementations a database or data store remote to an authentication service may be utilized (as illustrated in FIG. 26).

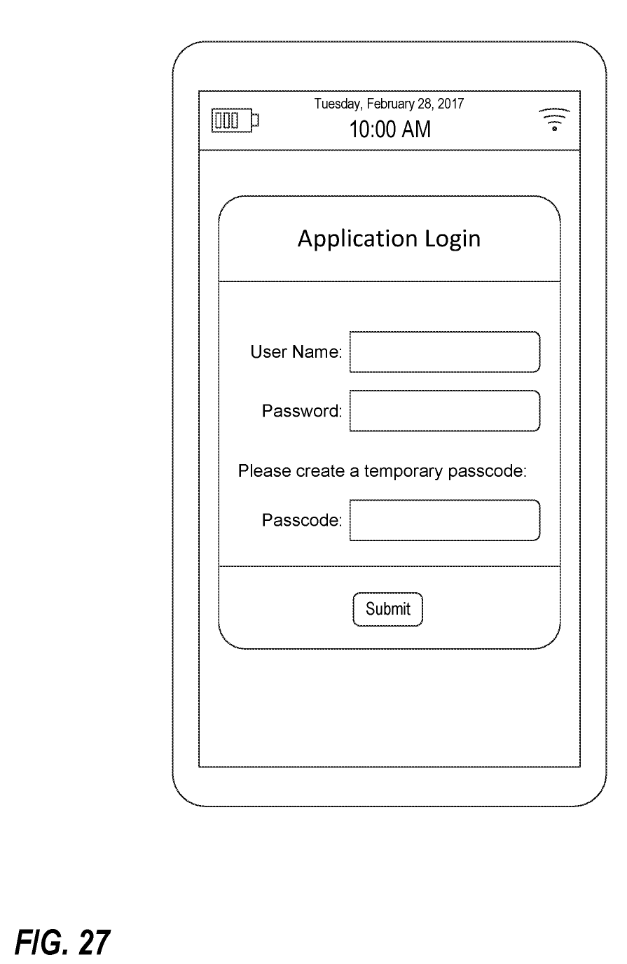

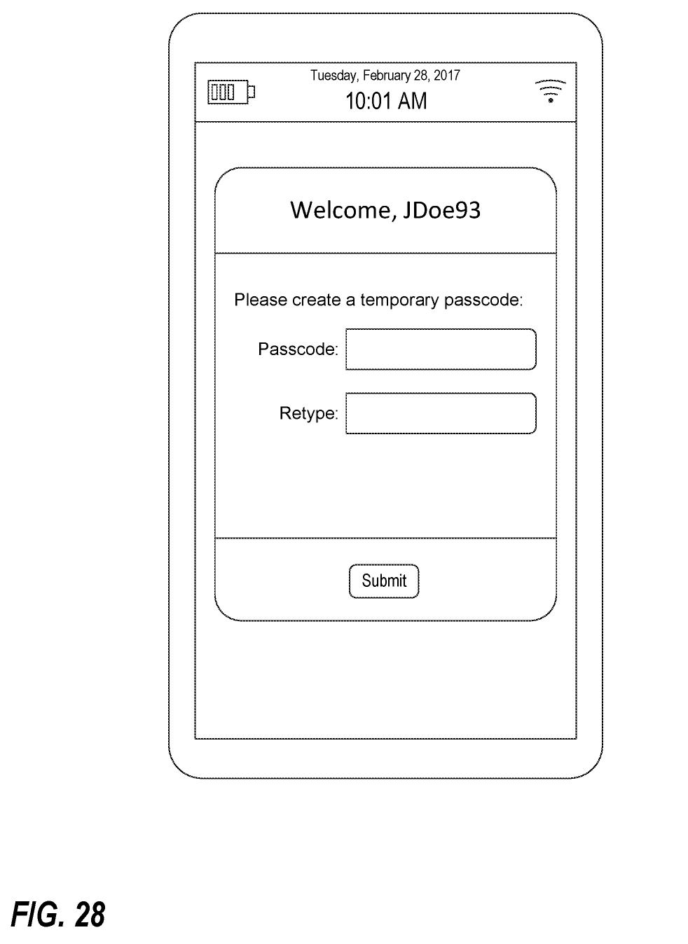

Although disclosure herein has largely focused on exemplary implementations in which a session passcode is input only after initial authorization credentials, in accordance with one or more preferred implementations, a session passcode may be input together with authorization credentials, as illustrated in FIG. 27. Additionally, in accordance with one or more preferred implementations, a user interface is configured to require confirmation of a user passcode for generation, as illustrated in FIG. 28.

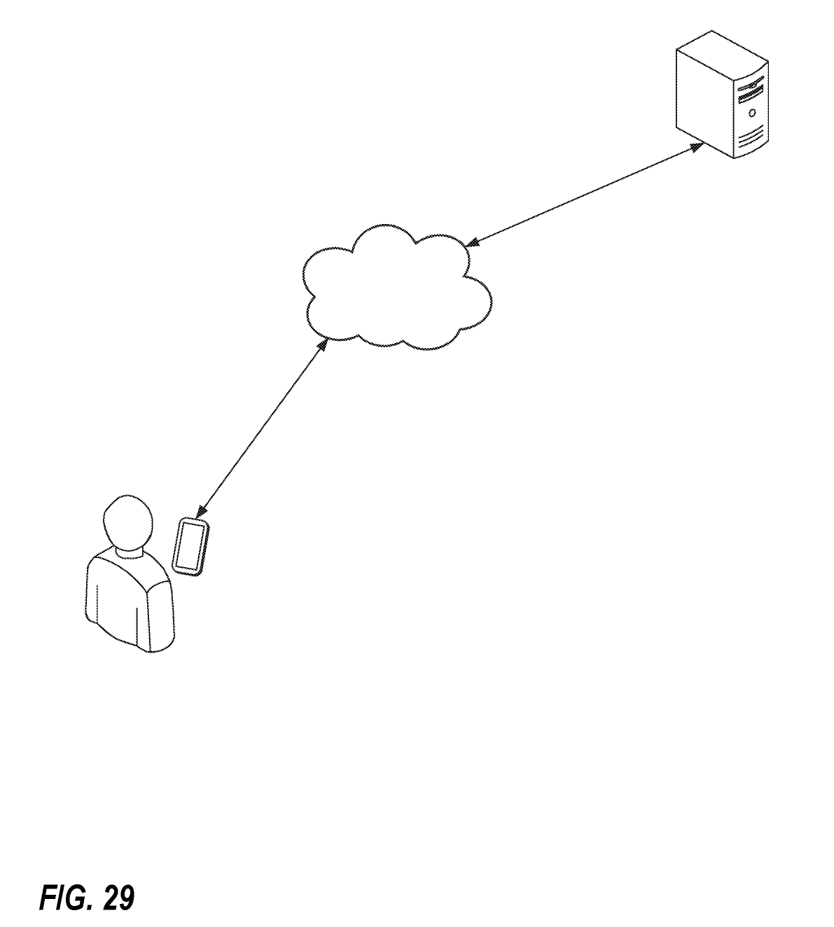

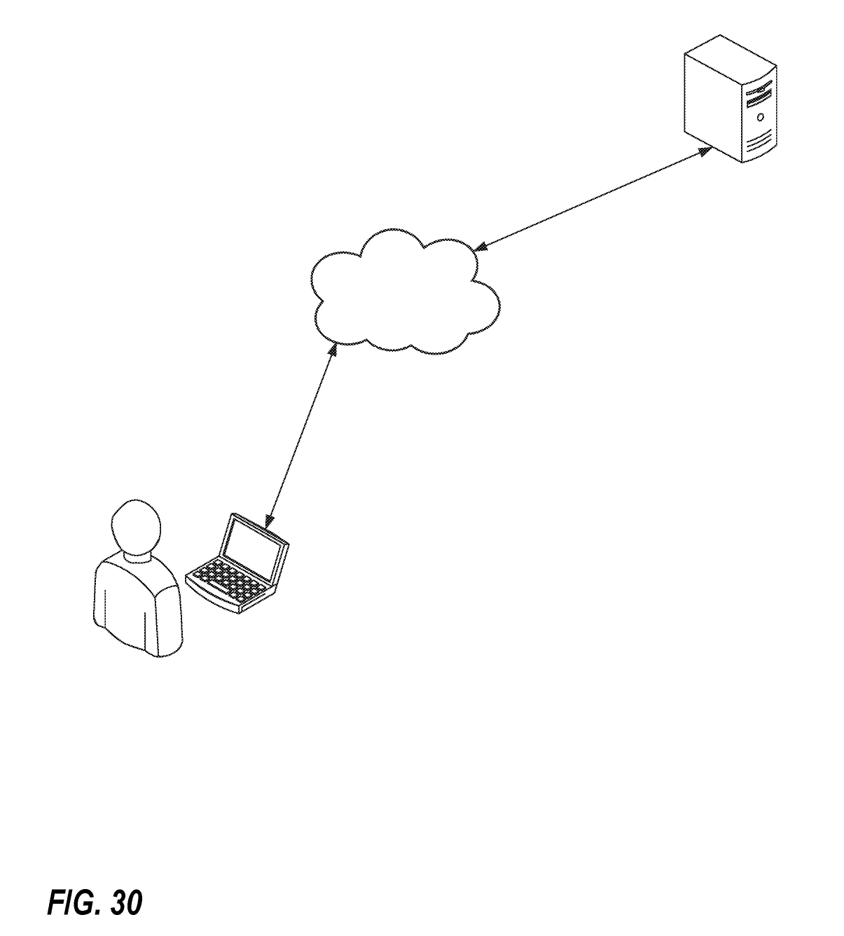

Although disclosure herein has largely illustrated an exemplary device representing a mobile computing device in the form of a phone (as illustrated in FIG. 29), methodologies and systems disclosed herein may be utilized with any computing device, such as a laptop computer (as illustrated in FIG. 30), a desktop computer, a tablet computer, a smart watch, a slate computer, a smart appliance, etc.

In accordance with one or more preferred implementations, a system requires the generation of a temporary passcode or other temporary authorization credentials by a human, or other autonomous entity, after normal log in procedures are followed. As it is user generated it can easily be remembered for the session. If it is forgotten, the user can regenerate a further temporary passcode. The extra level of security the temporary passcode confers will allow multiple advantages such as: extending the need for timeout before a full username and password needs to be entered; and/or using the temporary passcode every time a sensitive area of the electronic system is accessed.

In accordance with one or more preferred implementations, on log in, or upon token generation, a user creates a very memorable and low-complexity additional piece of information. This might be a four-digit PIN, a short word or phrase, or they could—for example—select a combination of a number and color or a picture from a list.

In accordance with one or more preferred implementations, once a user has logged in, a system will not keep asking the user for his or her relatively complex authentication details, but when the user wants to add or view sensitive information or stay in the system for longer the user must provide the short PIN/phrase/select the correct listed items. If the user gets it wrong a defined number of times (from one upwards), the user is logged out.

In accordance with one or more preferred implementations, a session passcode or temporary authorization credentials are stored in temporary storage inside a computer access system, in a protected database, and not kept in any cookies or session variables that might be accessible to a hacker. On log out, or token expiry, or at the end of a predefined time or number of sessions, the session passcode or temporary credentials are destroyed. In one or more preferred implementations, a session passcode or temporary credentials could be kept for a period to prevent a user from choosing the same session passcode or temporary credentials repeatedly. Preferably, for high security systems, every time a user logs in, her or she chooses a new session passcode or temporary credentials. Preferably, this means that a user will not need to write temporary credentials down in order to remember them as they were very recently chosen, and if they do write them down they will become useless to an attacker within the defined period of expiration.

In accordance with one or more preferred implementations, when a token is generated, a hash of a session passcode is stored with it. Subsequently, the token cannot be used without the correct session passcode, so even if the token is stolen so that a hacker can access the system in general, as soon as the attacker tries and fails to access any user data (not knowing the session passcode), the attacker will be locked out and the token will be revoked. In accordance with one or more preferred implementations, three or less attempts are allowed to prevent brute force attackers from “cracking” the session passcode. Provided that a user is not permitted to choose runs of numbers (e.g., 1234), repeated numbers (e.g., 0000), dictionary words (e.g., pencil) or similar it will be very hard for an attacker to hack the system.

Methodologies in accordance with one or more preferred implementations serve to protect a user in the case that he or she wanders off leaving his or her terminal logged in, serve to protect a user against having an authorization token stolen (e.g., hacked), and obviate the requirement for a user to remember or maintain additional authorization information for an extended period of time, which need to maintain additional information for an extended period of time might cause the user to write down the additional information.

In accordance with one or more preferred implementations, systems and methodologies disclosed herein are combined with clear education to users regarding the selection of passwords that are long with a range of characters which can be easily remembered and never written down (e.g., my_18_little-blue*horse—very nearly as hard for a computer to crack as a random string of the same length but without the downside that you have to write it down). In accordance with one or more preferred implementations, methodologies are fast enough as to not disrupt a user's workflow too much whilst protecting system access.

In accordance with one or more preferred implementations, password education involves informing users not to use their bank card PIN, not to repeat their session passcode, and to use a password that the user can remember without writing down and which the user does not and will not use for other systems. In accordance with one or more preferred implementations, a system may be configured to offer a selection of randomly generated memorable passwords for inspiration, together with an instruction to change at least one element of the randomly generated password. Exemplary randomly generated passwords may comprise sets of colors, letters, numbers, and special characters mixed with dictionary words.

In accordance with one or more preferred implementations, a user generates a single session passcode after normal authentication protocols have been used to access a system. This single session passcode can be used for the rest of the session to allow the user to access sensitive data or areas within the system, without requiring full re-authentication. This solves problems associated with a user having to repeatedly authenticate himself or herself in a system. It allows the user to generate his or her own passcode for every session avoiding the need to remember multiple passcodes. It also allows for the user to spend longer time in less sensitive areas of a system before sensitive authentication time out which is generally defined by the most sensitive areas of a system. It also provides an auditing layer that records when a user has accessed a sensitive area in a system. This methodology improves workflow, security, and audit of use within systems that have a differential between security sensitivities in those systems.

In accordance with one or more preferred implementations, a user who generates temporary authorization credentials may be any autonomous agent including a person, animal, or artificially intelligent entity. In accordance with one or more preferred implementations, a user authenticates with a secure system in a manner that can range from static single factor authentication to a combination of static and dynamic multifactor authentication.

This authentication can include, for example: a username and password; biometric authentication including facial recognition, fingerprint scanning, ear scanning, retinal scanning, electrocardiogram analysis, pulse analysis, and gait analysis; a dynamic session limited computer generated passcode using cryptography or other techniques; authentication by another user who is physically local (e.g., authentication by a person who supports a user with a learning disability before the user accesses a sensitive system either for assessment or for work, for example the other person could log onto the system, validate the user and then leave the user to generate a session passcode); authentication by another user who is remote (e.g., this could be done through video link where a remote person logs into the system and verifies the user by video link and logs them into the system where they are prompted to create a session passcode).

In any event, following initial authentication, in accordance with one or more preferred implementations, a user is prompted to generate one or more temporary authorization credentials. The form of such temporary authorization credentials can vary depending on system security requirements and user abilities.

In accordance with one or more preferred implementations, a system is configured to prompt a user to: generate a four to six digit PIN that the user will use to reauthenticate himself or herself for the rest of the session; generate a four to eight character word that the user will use to reauthenticate himself or herself for the rest of the session; choose a number of presented images (e.g., between two and four) that the user will use as his or her passcode for the rest of the session (this could be useful for people with cognitive impairment who may choose images of people they know or objects that are familiar to them); say a word or number sequence that the user will use to reauthenticate himself or herself for the rest of the session (this might, for example, combine voice recognition and the passcode or facial, voice, and passcode recognition); say “hello”, which will be the user's passcode for the rest of the session (this method might provide a simple word at random from a pre-defined library, which could be useful for people with cognitive impairment); or answer a question that will then be asked again later (e.g., the system queries what the user had for breakfast; this question can be a question from a library of predefined questions, with voice and/or text input into the system).

Other methodologies may be utilized as well. In accordance with one or more preferred implementations, a passcode is comprised of a series of facial expressions.

In accordance with one or more preferred implementations, a user is initially presented with a variety of options for creating a passcode that might, for example, include the examples described above. This would add a further layer of complexity to anyone trying to hack the system.

In accordance with one or more preferred implementations, a methodology might involve any combination or permutation of the above.

In accordance with one or more preferred implementations, a passcode is generated by a user's preference for presented options, some of which may be fixed and some of which may change over time. This is useful for users with limited or diminished cognitive abilities. This could even be utilized, for example, for an animal which you would like to be able to enter a compound. Different animals are likely to have different food preferences, and access to a compound or a particular area of a compound may be gated by switches that are activated through consumption of certain food sources. Consumption of a certain food source or a certain combination of food sources may enable access to the compound or area of the compound. This may allow access to certain animals while preventing access by certain predators (or even poachers) that would not necessarily choose the same food source or combination of food sources. In accordance with one or more preferred implementations, presented food may be destroyed afterwards so that a predator or poacher could not learn a pattern of selection.

In accordance with one or more preferred implementations, a system can be configured to check whether input for use as one or more temporary authorization credentials is the same as previously utilized temporary authorization credentials, and disallow repeated use of the same temporary authorization credentials. For variable system security, this could be set to the last x number of utilized temporary credentials or all previous temporary credentials.

In accordance with one or more preferred implementations, if input desired temporary authorization credentials are the same as previous temporary authorization credentials and this is not allowed, then a user will be prompted to input or generate different temporary authorization credentials.

Preferably, once acceptable temporary authorization credentials have been generated, they will be stored in a secure database separate from other security related elements.

In accordance with one or more preferred implementations, such a database can be either associated with an account or it can be localized, such as on a user's device. For example, in the case of using a mobile app to access data, the app may have securely stored data or downloaded sensitive data from a central server. In accordance with one or more preferred implementations, in order to view this data or upload it to the server, temporary authorization credentials such as a session passcode would be required. This prevents a person who has stolen or borrowed the device from using it to interfere with sensitive personal information, without forcing the user to continually log in and out of the app (which would form a barrier to use).

In accordance with one or more preferred implementations, a system owner or administrator can define when there is a requirement for temporary authorization credentials to be used.

In accordance with one or more preferred implementations, temporary authorization credentials are used for rapid access when a system is going to time out. In an exemplary implementation, a system which would normally time out after five minutes of inactivity is instead set to time out after sixty seconds of inactivity allowing a user up to four hours to put in their temporary authorization credentials. This both increases security by decreasing the window for potential unauthorized intruder access whilst allowing a user to easily revalidate on the system a long time after the normal time out.

In accordance with one or more preferred implementations, it is possible to shorten the amount of time that a sensitive page is open and visible. If the user is in a sensitive area, temporary authorization credentials can be set to be required on much shorter periods of inactivity, or a system may be set to require temporary authorization credentials regardless of the level of activity, or based on certain types of user behavior (repeated data requests or multiple data uploads for instance). Different sorts of data access (or data creation) can have their temporary authorization credential criteria specified differently.

Furthermore, the entry of temporary authorization credentials provides an auditable record of when a user accesses each sensitive area on the system.

In accordance with one or more preferred implementations, temporary authorization credentials are utilized for rapid access to more sensitive areas of a system. In an exemplary implementation, a user who has been using a system as normal wants to access more sensitive information and is prompted for his or her temporary authorization credentials. The user provides his or her temporary authorization credentials and gains access to the more sensitive information. This provides a further level of system security. For instance, if an unauthorized person gained access to the system in the sixty seconds from last use when the normal prompt for temporary authorization credentials was required, the person still would not be able to access the sensitive materials without entering the temporary authorization credentials. Furthermore, the entry of the temporary authorization credentials facilitates an auditable record of when a user accesses a sensitive area of the system.

Many systems allow remote access via encrypted authentication tokens. There is a security risk in the use of tokens, as if they are intercepted or stolen they can be used by another party to access user data up until the point at which they expire. Secure systems require short expiry times, after which the user has to refresh their token.

In accordance with one or more preferred implementations, to add further security, temporary authorization credentials may be combined with a session token or authorization token (e.g., an OAuth token), where neither would be a valid way of authenticating a user without the other. In this way, even if a token was stolen, an unauthorized user would not be able to access the system. FIG. 31 illustrates an exemplary flow for a system in accordance with one or more preferred implementations.

In accordance with one or more preferred implementations, temporary authorization credentials are hashed and integrated into a session token or a decryption key in an obfuscated way. Utilizing this methodology would mean that the temporary authorization credentials could not be recovered if the token/key was stolen. To check the validity of the temporary authorization credentials on further logins, the temporary authorization credentials would be hashed using the identical methodology to the original temporary authorization credentials and session token integration. The characters would then be compared in the combined temporary authorization credentials and original session token to allow the user to continue access or to access the sensitive area if they match.

In accordance with one or more preferred implementations, hashing/obfuscation of temporary authorization credentials can occur at an electronic system (e.g., at an authentication service of the electronic system), in which case an encrypted application programming interface (API) call to the electronic system (e.g., a server or service) would be required to check that the temporary authorization credentials entered by the user at the user device (or user system) matched the token. This could occur either at the start of the interaction (after which the temporary authorization credentials could be temporarily held in memory on the device in a secure way if needed) or with each temporary authorization credentials-required access depending on the use case. A repeated API call is a secure way to access a system if the user device storage itself is not very secure, as it prevents the temporary authorization credentials from needing to be being stored on the user device (or user system) at all.

Alternatively, the hashing/obfuscation could happen at a user device. In this case, the hashed temporary authorization credentials would be sent to the electronic system, which would generate an authentication token, with the hashed version of the temporary authorization credentials attached in some way (appended, prepended, inserted, or interleaved) and returned to the device. This allows authentication using the temporary authorization credentials to happen entirely on a user device. The temporary authorization credentials are not stored at the electronic system, and if the token is transferred to another device then even if the user knows the temporary authorization credentials, authentication will still fail. This ties the access to the device itself.

In accordance with one or more preferred implementations, the number of times temporary authorization credentials can be incorrectly entered before complete logout could be limited from one upwards. This would further enhance security and effectively neutralize the risk of a brute force attack guessing the temporary authorization credentials.

In accordance with one or more preferred implementations, after log out, a user must log in again using their primary, more secure access methodology (such as username and password) before generating new temporary authorization credentials. In accordance with one or more preferred implementations, it is possible to store “used” temporary authorization credentials for each user and bar users from re-using older temporary authorization credentials forever, or for a certain period of time, in order to increase security.

In accordance with one or more preferred implementations, following login to an electronic system or application via an electronic device, a user is prompted to input temporary authorization credentials, e.g., a session passcode. In accordance with one or more preferred implementations, a hash of these temporary authorization credentials is securely stored. This could be stored locally at the electronic device in the same file system, locally in a different file system, virtually at the electronic device, locally on a different virtual machine at the electronic device, in a cloud, at a remote server, at an electronic access system, at a remote data store, at a physically proximate device, etc. Subsequently, upon a triggering event, a user of the electronic device will be prompted for input of the temporary authorization credentials. These input temporary authorization credentials will be hashed in the same manner as the original temporary authorization credentials, and the hashes will be compared. If there is a match, the user is re-authenticated. In this way, access to an electronic system or application is gated by the session passcode. If a user is unable to re-enter the correct session passcode, then full re-login will be required.

In accordance with one or more preferred implementations, following login to an electronic system or application associated with an electronic system via an electronic device, an authorization token is returned to the electronic device and stored at the electronic device, and a user is prompted to input temporary authorization credentials, e.g., a session passcode. In accordance with one or more preferred implementations, these temporary authorization credentials or a hash of these temporary authorization credentials are communicated to the electronic system. The temporary authorization credentials, or a hash thereof, or an integrated token containing the temporary authorization credentials or a hash thereof, are stored at the electronic system. Subsequently, upon a triggering event, a user of the electronic device will be prompted for input of the temporary authorization credentials. These input temporary authorization credentials will be hashed and integrated into the authorization token stored at the electronic device. The integrated authorization token will be communicated from the electronic device to the electronic system where it is compared to an integrated token integrating the previously communicated session passcode or hashed session passcode. If there is a match, the user is re-authenticated. In this way, access to an electronic system or application is gated by the session passcode. If a user is unable to re-enter the correct session passcode, then full re-login will be required.

In accordance with one or more preferred implementations, in a decryption key context, systems and methods disclosed herein are utilized to partially solve issues with contemporary offline security of devices that store sensitive information. Current systems that need offline secure information typically need to have both the decryption key and the encrypted data stored on the same devices. Even when these are in separate file areas, an experienced hacker is often able to access the decryption key and hence is able to unlock the encrypted data. In accordance with one or more preferred implementations, adding a further step which is changed per user access, and can potentially be held in memory for the duration of the session, further increases the barriers for a hacker to access personal information.

In accordance with one or more preferred implementations, following login to an electronic system or application via an electronic device or access of data within the electronic system or application, a user is prompted to input temporary authorization credentials, e.g., a session passcode. In accordance with one or more preferred implementations, a hash of these temporary authorization credentials is utilized to encrypt data for the electronic system or application, where a decryption key is generated which is incomplete in that it needs the session passcode or a hash of the session passcode inserted in order to be complete. Subsequently, if a user wants to access the encrypted data, the user will be prompted for input of the temporary authorization credentials. These input temporary authorization credentials will be hashed in the same manner as the original temporary authorization credentials, and the hashes will be compared. If there is a match, the user is re-authenticated. In this way, access to data from an electronic system or application is gated by the session passcode. If a user is unable to re-enter the correct session passcode, then full re-login will be required.

In accordance with one or more preferred implementations, at the termination of a session, temporary authorization credentials are destroyed from a temporary authentication database and the temporary authorization credentials would be archived where they could, depending on security preferences as defined above, be used to ensure temporary authorization credentials, or elements of temporary authorization credentials (similarities), are not repeated, or only able to be repeated after a set time period.

In accordance with one or more preferred implementations involving lower security requirements on the system and a need for increased usability, temporary authorization credentials may survive for more than one session on a physical computer. In this situation, the user has finished the session through either logging out or timing out. The temporary authorization credentials are preserved and on login the user is presented with two options which is to either log in as the last user with the temporary authorization credentials or standard log in, requiring the normal authentication process for the system. This embodiment does not have the same security as the previous embodiments; however, it does provide a very convenient way for a user to access the system. As soon as a different user logs into the same physical computer, the temporary authorization credentials associated with the previous user are destroyed.

In accordance with one or more preferred implementations for even less secure systems, temporary authorization credentials are preserved for several users of a system for variable amounts of time or sessions or conditions. The persistence of the temporary authorization credentials will always be limited depending on the system configuration.

In accordance with one or more preferred implementations, temporary authorization credentials or a session limited passcode are utilized for generation of a decryption key and/or an encryption key. In accordance with one or more preferred implementations, data is encrypted by an electronic system before communication to a user device, and the temporary authorization credentials or session limited passcode for a user of the electronic device can be utilized for generation of a decryption key for decryption of the communicated encrypted data.

Although sometimes described herein in the context of applications, in accordance with one or more preferred implementations a web application or web page or other resource is configured to utilize or is utilized in systems and methodologies disclosed herein.

An exemplary use case in accordance with one or more preferred implementations will now be described with reference to an exemplary user, Mark. Mark left school before attaining any formal qualifications as he found studying very difficult because he had a decreased capacity compared to his peers for learning. He started working in a care home as a cleaner. After eighteen months, Mark made an internal shift in the organization as a caregiver's assistant. Another two years later he was promoted to being a caregiver. As a caregiver, Mark was required to access the care home computer system to make notes and record medication usage by the residents of the care home. As this was a secure system that could access the personal details of several residents, a twelve character, unique passcode of combined alphanumeric characters and symbols was required to access this. Also, due to security requirements, the system timed out after five minutes of not using it. As Mark had a poor memory, his passcode was written down and stored in a locked cabinet with him and his supervisor being the only people with the key. Due to the time out and being busy with tasks, Mark would have to retrieve the passcode from the cabinet several times a day. This increased the risk of Mark forgetting to put the passcode back in the cabinet and took considerable time out of Mark's working day.

A session-limited user passcode system was implemented into the computer system at the care home Mark worked at. Mark generated a session-limited user passcode every day that was based off easy to remember things known by him such as his dinner breakfast combination with either the date or the number of people he had been looking after. Mark was required to enter his session-limited user passcode every sixty seconds after inactivity. Due to this extra layer of security, the time out on the normal authentication was increased to four hours. Mark occasionally forgot his session-limited passcode but overall it saved roughly forty-five minutes a day, and improved both the system security and Mark's job satisfaction.

The above example could be modified for the use case for any person who is required to access a sensitive area, either physical or virtual, during their day to day activities. One or more preferred implementations could be utilized in any industry or area, including, by way of non-limiting example, banking, finance, government, military, education, energy, healthcare, legal, law enforcement, research and development, and transport.

Although described herein largely in the context of electronic systems, and in the context of implementations in which passcodes, databases, and storage are implemented using electronic computing hardware, in accordance with one or more preferred implementations, systems and methodologies disclosed herein are implemented on a physical or biological system using either locked storage or memory for the storage, retrieval and cross-checking of user generated passcodes or temporary authorization credentials.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A method comprising:
(I) first,
(a) receiving, from a user via one or more input devices associated with an electronic device, user input corresponding to authorization credentials for an electronic system;
(b) communicating, from the user device to an authentication service for the electronic system, authentication information for the user based on the input authorization credentials;
(c) determining, by the authentication service based on the received authentication information, that the user is an authorized user, and based thereon returning an authentication indication to the user device;
(d) receiving, at the user device, the authentication indication, and based thereon, displaying, to the user via a display associated with the electronic device, an interface soliciting entry of a session passcode;
(e) receiving, at the user device from the user via one or more input devices associated with the electronic device, user input corresponding to entry of a session passcode;
(f) communicating, from the electronic device to the authentication service, an indication of the session passcode; and
(g) storing, by the authentication service at a secure database associated with the electronic system, a hash of the session passcode; and
(II) thereafter,
(a) determining that a timeout period has passed since user activity at the user device;
(b) based on the determination that a timeout period has passed since user activity at the user device, displaying, to the user via a display associated with the electronic device, an interface soliciting entry of the session passcode;
(c) receiving, at the user device from the user via one or more input devices associated with the electronic device, user input corresponding to entry of a suspect session passcode;
(d) communicating, from the electronic device to the authentication service, an indication of the suspect session passcode;
(e) comparing, by the authentication service, a hash of the suspect session passcode to the stored hash of the session passcode and determining that the hash of the suspect session passcode matches the stored hash of the session passcode;
(f) based on the determination that the hash of the suspect session passcode matches the stored hash of the session passcode, communicating, by the authentication service, a re-authentication indication to the electronic device; and
(g) receiving, at the electronic device, the communicated re-authentication indication, and, based thereon, allowing the user continued access to the electronic system.

2. (canceled)

3. The method of claim 1, wherein the electronic system comprises an online platform.

4. The method of claim 1, wherein the electronic system comprises a server.

5. (canceled)

6. The method of claim 1, wherein the electronic system comprises a medical records system.

7. The method of claim 1, wherein the authorization credentials comprise a username and password.

8. The method of claim 1, wherein the authorization credentials comprise biometric authentication.

9. The method of claim 1, wherein the authorization credentials comprise a retinal scan or fingerprint scan.

10-11. (canceled)

12. The method of claim 1, wherein the electronic device comprises a phone.

13. The method of claim 1, wherein the electronic device comprises a tablet.

14. The method of claim 1, wherein the electronic device comprises a touchscreen device; and wherein receiving, at the user device from the user via one or more input devices associated with the electronic device, user input corresponding to entry of a session passcode comprises receiving user input via a touchscreen of the touchscreen device.

15. The method of claim 1, wherein the session passcode comprises an alphanumeric string.

16. The method of claim 1, wherein the session passcode comprises a personal identification number.

17. The method of claim 1, wherein the session passcode comprises one or more user-selected images.

18. The method of claim 1, wherein the authentication service is remote from the electronic device.

19. The method of claim 1, wherein the authentication service is local to the electronic device with virtual or close physical separation.

20. The method of claim 1, wherein the authentication service is remote from servers forming part of the electronic system.

21-28. (canceled)

29. A method comprising:
(I) first,
(a) receiving, from a user via one or more input devices associated with an electronic device, user input corresponding to full authorization credentials for an electronic system;
(b) communicating, from the user device to the electronic system, authentication information for the user based on the input full authorization credentials;
(c) determining, by the electronic system based on the received authentication information, that the user is an authorized user, and based thereon returning an authentication indication to the user device;
(d) receiving, at the user device, the authentication indication, and based thereon, displaying, to the user via a display associated with the electronic device, an interface soliciting entry or selection of temporary authentication credentials;
(e) receiving, at the user device from the user via one or more input devices associated with the electronic device, user input corresponding to entry or selection of temporary authorization credentials;
(f) communicating, from the electronic device to the electronic system, an indication of the temporary authorization credentials; and
(g) storing, by the electronic system at a secure database associated with the electronic system, data corresponding to the temporary authorization credentials; and
(II) thereafter,
(a) determining that an event has occurred requiring re-authentication;
(b) based on the determination that an event has occurred requiring re-authentication, displaying, to the user via a display associated with the electronic device, an interface soliciting entry of the temporary authorization credentials;
(c) receiving, at the user device from the user via one or more input devices associated with the electronic device, user input corresponding to entry of suspect temporary authorization credentials;
(d) communicating, from the electronic device to the electronic system, an indication of the suspect temporary authorization credentials;
(e) comparing, by the electronic system, data corresponding to the suspect temporary authorization credentials to the stored data corresponding to the temporary authorization credentials and determining that they match;
(f) based on the determination that they match, communicating, by the electronic system, a re-authentication indication to the electronic device; and
(g) receiving, at the electronic device, the communicated re-authentication indication, and, based thereon, allowing the user continued access to the electronic system.

30. The method of claim 29, wherein temporary authorization credentials are utilized for generation of a decryption key.

31. The method of claim 29, wherein data is encrypted by the electronic system before communication to the electronic device, and the temporary authorization credentials can be utilized as a decryption key for decryption of the communicated encrypted data at the electronic device.

32-40. (canceled)

41. A method comprising:
(I) first,
(a) receiving, from a user via one or more input devices associated with an electronic device, user input corresponding to full authorization credentials;
(b) determining, based on the received full authorization credentials, that the user is an authorized user, and based thereon displaying, to the user via a display associated with the electronic device, an interface soliciting entry or selection of temporary authentication credentials;
(c) receiving, at the user device from the user via one or more input devices associated with the electronic device, user input corresponding to entry or selection of temporary authorization credentials; and
(d) securely storing data corresponding to the temporary authorization credentials; and
(II) thereafter,
(a) determining that an event has occurred requiring re-authentication of the user;
(b) based on the determination that an event has occurred requiring re-authentication, displaying, to the user via a display associated with the electronic device, an interface soliciting entry of the temporary authorization credentials;
(c) receiving, at the user device from the user via one or more input devices associated with the electronic device, user input corresponding to entry of suspect temporary authorization credentials;
(d) electronically comparing data corresponding to the suspect temporary authorization credentials to the stored data corresponding to the temporary authorization credentials and determining that they match; and
(e) based on the determination that they match, re-authenticating the user.
